(19) United States
(12) Patent Application Publication
(10) Pub. No.: US 2026/0218863 A1
(43) Pub. Date: Jul. 30, 2026

(54) TUNABLE BEAM COMPRISING LASER PHOSPHOR ENGINE

(71) Applicant: SIGNIFY HOLDING B.V., EINDHOVEN (NL)

(72) Inventor: CHRISTOPH GERARD AUGUST HOELEN, VALKENSWAARD (NL)

(21) Appl. No.: 19/152,039

(22) PCT Filed: Jan. 29, 2024
(86) PCT No.: PCT/EP2024/052063

§ 371 Date: Jul. 30, 2025

(30) Foreign Application Priority Data
Feb. 2, 2023 (EP) 23154768.8

(51) Int. Cl. F21K 9/64; F21Y 115/30; G02B 27/14; G02B 27/28

(52) U.S. Cl. CPC F21K 9/64; G02B 27/141; G02B 27/283; F21Y 2115/30

(57) ABSTRACT

The invention provides a light generating system (1000) comprising a first light generating device (110), a second light generating device (120), a luminescent material (200), first optics (510), a polarization control element (610), a diffuser element (710), a polarization changing element (810), and central optics (900); wherein the light generating system (1000) is configured to provide system light (1001) comprising one or more of diffused second device light (711) and luminescent material light (201); and wherein the light generating system (1000) is configured such that in a first operational mode of the light generating system (1000) (a) at least part of the first device light (111) irradiates the luminescent material (200) via the first optics (510), and the luminescent material light (201) escapes from the light generating system (1000) via the first optics (510) and the central optics (900), and (b) at least part of the second device light (121) irradiates the diffuser element (710) via the central optics (900), and at least part of the diffused second device light (711) escapes from the light generating system (1000) via the central optics (900).

### FIELD OF THE INVENTION

The invention relates to a light generating system. The invention further relates to a lighting device comprising such light generating system.

### BACKGROUND OF THE INVENTION

Laser-phosphor based stage lighting engines are known in the art. For instance, WO2022143318 describes a light emitting device, comprising a first light source, a second light source, a dichroic mirror, a wavelength conversion apparatus, a first light path adjusting apparatus or a second light path adjusting apparatus, and a first scattering optical system. The light mixing effect of emergent light can be improved by using the first scattering optical system. Light emitted by the first light source is all used for exciting the wavelength conversion apparatus.

US 2017/329212 A1 discloses a light source apparatus which includes a light source section having a first area and a second area, a first condensing optical system, a second condensing optical system, a wavelength conversion element, a reflection element, and a wavelength selective polarization element. The first area and the second area respectively emit a first light ray flux and a second light ray flux. The first light ray flux passes through the first condensing optical system to excite the wavelength conversion element. The excited wavelength conversion element emits fluorescence. The second light ray flux passes through the wavelength selective polarization element and the second condensing optical system to enter the reflection element. The wavelength selective polarization element transmits the fluorescence irrespective of the polarization state of the fluorescence to combine the second light ray flux reflected by the reflection element with the fluorescence.

JP 2016 186566 A discloses an illumination device which outputs a beam of first color light in a first wavelength range and a second color light in a second wavelength range different from the first wavelength range. The illumination device includes: a first light source unit that emits an excitation ray in a third wavelength range; a second light source unit that emits a lay of light in the second wavelength range; a fluorescent body layer that emits the first color light; a detection unit that detects the strength of the first color light and the strength of the second color light; and a light source controller that controls the ratio of the amount of light emitted from the second light source unit with respect to the amount of the excitation ray on the basis of the detection result made by the detection unit.

WO 2022/143318 A1 discloses a light emitting device, comprising a first light source, a second light source, a dichroic mirror, a wavelength conversion apparatus, a first light path adjusting apparatus or a second light path adjusting apparatus, and a first scattering optical system. The light mixing effect of emergent light can be improved by using the first scattering optical system. The color temperature of the emergent light of the light emitting device can be freely adjusted by independently adjusting the power of the first light source and the power of the second light source. A laser capable of emitting light of different dominant wavelengths can be used in the second light source to improve the color rendering index of the emergent light of the light emitting device. Light emitted by the first light source in the present invention is all used for exciting the wavelength conversion apparatus. The light emitting device can achieve output of higher light flux in the case that an optical expansion amount is not increased, and if a polarization selection element is used in the first light source in a matching mode, the output of light flux of the light emitting device can be further improved.

US 2022/011659 A1 discloses a light source apparatus which includes light sources emitting first and second polarized light, an optical element transmitting one of the polarized light and reflecting the other, a polarization rotator generating polarization rotated light from the first polarized light, a wavelength convertor converting the second polarized light into wavelength converted light, and a controller. The optical element generates emitted light by combining the wavelength converted light and polarization rotated light. The controller acquires respective deterioration amounts of the light sources, and controls, based on respective changes in light emission amounts from the light sources acquired from the deterioration amounts, the light emission amount from at least one of the light sources for making different respective change amounts of the light emission amounts from the light sources, or changing a ratio between respective light emission amounts from the light sources.

### SUMMARY OF THE INVENTION

High brightness light sources can be used in various applications including spots, stage-lighting, headlamps, home and office lighting, and automotive lighting. For this purpose, laser-phosphor technology can be used, wherein a laser provides laser light and a remote phosphor converts laser light into converted light. A relatively straightforward way to produce white light using lasers is to use laser light in combination to generate phosphor converted light. Laser-phosphor systems may allow generation of high brightness light and may therefore be used in projection systems, including displays such as cinema projectors and projectors for home, school, and office applications, car front lighting, search lighting, stage lighting, architectural lighting, and special lighting applications. However, such light engine may be capable to generate only a single color point as defined by the luminescent converter. Creation of a product range providing different color points may be difficult as it may require multiple unique components to be designed, qualified, produced, and kept in stock. In other cases, e.g. in RGB LCD-based projection systems, the maximum brightness may be limited by the components used, the engine volume may be large due to the many components, and the system cost may be high due to the many dedicated components. A way to combine pump light and luminescent light may be to use a polarizing beam splitter for the pump light, by which part of the light is reflected to the luminescent material and part is transmitted to a diffuser. However, in general the diffused light may to a large degree be depolarized, which may result in relatively high losses of diffused blue light at the beam combiner where it is combined with the luminescent light into white output light.

Hence, it is an aspect of the invention to provide an alternative light generating system, which preferably further at least partly obviates one or more of above-described drawbacks. The present invention may have as an objective to overcome or ameliorate at least one of the disadvantages of the prior art, or to provide a useful alternative.

According to a first aspect, the invention provides a light generating system (“system”) comprising a first light generating device, a second light generating device, a luminescent material, first optics, and a diffuser element. Further, the system may comprise a polarization control element, a polarization changing element, and central optics. In embodiments, the first light generating device may be configured to generate first device light. The first device light may comprise one or more of polarized light having a p polarization and polarized light having an s polarization; however, the device light may also be unpolarized light. Especially, in embodiments the first light generating device may comprise a first light source selected from a laser diode and a superluminescent diode. Further, the first device light may have a first peak wavelength λ1. Yet, in embodiments the second light generating device may be configured to generate second device light. The second device light may comprise one or more of polarized light having a p polarization and polarized light having an s polarization. Especially, in embodiments the second light generating device may comprise a second light source selected from a laser diode and a superluminescent diode. Further, the second device light may have a second peak wavelength λ2. In embodiments, |λ1−λ2|≥5 nm. More especially, in embodiments |λ1−λ2|≥10 nm. Especially, the luminescent material may be configured to convert first device light and/or second device light received by the luminescent material into luminescent material light. Yet, in embodiments the first optics may comprise a first dichroic beam splitter. Especially, the first dichroic beam splitter may be configured (a) to transmit or reflect at least part of the first device light, and (b) to reflect or transmit at least part of the luminescent material light. In embodiments, the polarization control element may be configured to control polarization of the second device light. Further, in embodiments the diffuser element may be configured to diffuse (by reflection) at least part of the first device light and/or second device light received by the diffuser element thereby providing diffused second device light while in specific embodiments maintaining at least part of the polarization of the (reflected) second device light. Yet, in embodiments the polarization changing element may comprises a λ/4 waveplate. Especially, the polarization changing element may be configured in an optical path of the second device light between the central optics and the diffuser element. In specific embodiments, the central optics may comprise (i) a central optics polarizing beam splitter, and (ii) a central optics dichroic beam splitter. In embodiments, the central optics polarizing beam splitter may be configured to transmit and/or reflect at least part of the second device light in dependence of its polarization. Yet, in embodiments the central optics dichroic beam splitter may be configured to (a) to transmit or reflect at least part of the second device light, and (b) to reflect or transmit at least part of the luminescent material light. Especially, the light generating system may be configured to provide system light comprising one or more of diffused second device light and luminescent material light. In embodiments, the light generating system may be configured such that in a first operational mode of the light generating system (a) at least part of the first device light may irradiate the luminescent material via the first optics, and the (thus generated) luminescent material light may escape from the light generating system via the first optics and the central optics, and (b) at least part of the second device light may irradiate the diffuser element via the central optics, and at least part of the (thus generated) diffused second device light may escape from the light generating system via the central optics. Hence, in specific embodiments the invention provides a light generating system comprising a first light generating device, a second light generating device, a luminescent material, first optics, a polarization control element, a diffuser element, a polarization changing element, and central optics, wherein: (A) the first light generating device is configured to generate first device light; wherein the first light generating device comprises a first light source selected from a laser diode and a superluminescent diode; wherein the first device light has a first peak wavelength λ1; (B) the second light generating device is configured to generate second device light, wherein the second device light comprises one or more of polarized light having a p polarization and polarized light having an s polarization; wherein the second light generating device comprises a second light source selected from a laser diode and a superluminescent diode; wherein the second device light has a second peak wavelength λ2; wherein |λ1−λ2|≥5 nm; (C) the luminescent material is configured to convert (at least part of) first device light and/or second device light received by the luminescent material into luminescent material light; (D) the first optics comprise a first dichroic beam splitter, wherein the first dichroic beam splitter is configured (a) to transmit or reflect at least part of the first device light, and (b) to reflect or transmit at least part of the luminescent material light; (E) the polarization control element is configured to control polarization of the second device light; (F) the diffuser element is configured to diffuse (by reflection) at least part of the first device light and/or second device light received by the diffuser element thereby providing diffused second device light while maintaining at least part of the polarization of the second device light; (G) the polarization changing element may in specific embodiments comprises a λ/4 waveplate; wherein the polarization changing element is configured in an optical path of the second device light between the central optics and the diffuser element; (H) the central optics comprises (i) a central optics polarizing beam splitter, and (ii) a central optics dichroic beam splitter; wherein the central optics polarizing beam splitter is configured to transmit and/or reflect at least part of the second device light in dependence of its polarization; and wherein the central optics dichroic beam splitter is configured to (a) to transmit or reflect at least part of the second device light, and (b) to reflect or transmit at least part of the luminescent material light; and (I) the light generating system is configured to provide system light comprising one or more of diffused second device light and luminescent material light; and wherein the light generating system is configured such that in a first operational mode of the light generating system (a) at least part of the first device light irradiates the luminescent material via the first optics, and the (thus generated) luminescent material light escapes from the light generating system via the first optics and the central optics, and (b) at least part of the second device light irradiates the diffuser element via the central optics, and at least part of the (thus generated) diffused second device light escapes from the light generating system via the central optics.

With such system, a high power light generating system may be provided. Further, such system may allow control of spectral power distribution of the system light (of a high power system). Yet, such system may in a safe way provide high power light. The system may be relatively compact. Yet, thermal management of the luminescent material may also be provided with this system. In addition to high optical power, the system may also provide high radiance (or luminance), i.e., a high optical power density of the source. The system may be more fail-safe thanks to the reflective configuration for both the luminescent light and the diffused light, by which it can be prevented that direct laser beams emit from the system in case the luminescent component or the diffusing component would fail (e.g. break, fall off, etc.). Of course the system may also function with a static luminescent converter, but in embodiments a phosphor wheel may be used here due to its good heat spreading and cooling properties. The diffuser typically dissipates far less energy and may not be in a need of such a rotatable configuration, although a rotatable configuration of the diffuser is also an embodiment herein. However, in embodiments the diffuser may also be realized in the form of a rotating wheel. For static luminescent converters in particular, liquid cooled converter configurations may also enable high optical power as well as high optical power density. Overall, a typical advantage may be that in embodiments from two (different) laser sources only part of one source may be used for diffusion and more than one source for luminescent conversion. Thereby, such embodiments may enable the most efficient use of a combination of two laser sources while also enabling maximum output light using two laser sources, e.g. when using two sources with comparable dimensions (e.g. the same number of laser diodes in convenient configurations). Therefore, amongst others in embodiments a tunable beam combining laser phosphor engine is provided, wherein the tunable beam combining laser phosphor engine may comprise (i) a dichroic beam splitter and (ii) central optics having at least a polarizing beam splitter function and dichroic beam splitter function.

As indicated above, the light generating system may in embodiments comprise a first light generating device, a second light generating device, a luminescent material, first optics, a polarization control element, a diffuser element, a polarization changing element, and central optics.

Hence, the light generating system may comprise at least two different types of light generating devices. A light generating device may especially be configured to generate device light. Especially, the light generating device may comprise a light source. The light source may especially configured to generate light source light. In embodiments, the device light may essentially consist of the light source light. In other embodiments, the device light may essentially consist of converted light source light. In yet other embodiments, the device light may comprise (unconverted) light source light and converted light source light. Light source light may be converted with a luminescent material into luminescent material light and/or with an upconverter into upconverted light (see also below). The term “light generating device” may also refer to a plurality of light generating devices which may provide device light having essentially the same spectral power distributions. In (other) specific embodiments, the term “light generating device” may also refer to a plurality of light generating devices which may provide device light having different spectral power distributions.

The term “light source” may in principle relate to any light source known in the art. It may be a conventional (tungsten) light bulb, a low pressure mercury lamp, a high pressure mercury lamp, a fluorescent lamp, an LED (light emissive diode). In a specific embodiment, the light source comprises a solid state LED light source (such as an LED or laser diode (or “diode laser”)). The term “light source” may also relate to a plurality of light sources, such as 2-2000 (solid state) LED light sources. Hence, the term LED may also refer to a plurality of LEDs. Further, the term “light source” may in embodiments also refer to a so-called chip-on-board (COB) light source. The term “COB” especially refers to LED chips in the form of a semiconductor chip that is neither encased nor connected but directly mounted onto a substrate, such as a PCB. Hence, a plurality of light emitting semiconductor light source may be configured on the same substrate. In embodiments, a COB is a multi LED chip configured together as a single lighting module.

The term “light source” may also refer to a chip scaled package (CSP). A CSP may comprise a single solid state die with provided thereon a luminescent material comprising layer. The term “light source” may also refer to a midpower package. A midpower package may comprise one or more solid state die(s). The die(s) may be covered by a luminescent material comprising layer. The die dimensions may be equal to or smaller than 2 mm, such as in the range of e.g. 0.2-2 mm. Hence, in embodiments the light source comprises a solid state light source. Further, in specific embodiments, the light source comprises a chip scale packaged LED. Herein, the term “light source” may also especially refer to a small solid state light source, such as having a mini size or micro size. For instance, the light sources may comprise one or more of mini LEDs and micro LEDs. Especially, in embodiment the light sources comprise micro LEDs or “microLEDs” or “μLEDs”. Herein, the term mini size or mini LED especially indicates to solid state light sources having dimensions, such as die dimension, especially length and width, selected from the range of 100 μm-1 mm. Herein, the term μ size or micro LED especially indicates to solid state light sources having dimensions, such as die dimension, especially length and width, selected from the range of 100 μm and smaller.

The light source may have a light escape surface. Referring to conventional light sources such as light bulbs or fluorescent lamps, it may be an outer surface of a glass or a quartz envelope. For LED's it may for instance be the LED die, or when a resin is applied to the LED die, the outer surface of the resin. In principle, it may also be the terminal end of a fiber. The term escape surface especially relates to that part of the light source, where the light actually leaves or escapes from the light source. The light source is configured to provide a beam of light. This beam of light (thus) escapes from the light exit surface of the light source.

Likewise, a light generating device may comprise a light escape surface, such as an end window. Further, likewise a light generating system may comprise a light escape surface, such as an end window.

A position where system light escapes from the light generating system may also be indicated as light exit. This may be a light transmissive window or an opening (in the system). The light transmissive window may in embodiments be provided by an optical component.

The term “light source” may refer to a semiconductor light-emitting device, such as a light emitting diode (LEDs), a laser diode, a resonant cavity light emitting diode (RCLED), a vertical cavity laser diode (VCSELs), an edge emitting laser (EEL), a photonic crystal surface emitting laser (PCSEL), a vertical external cavity surface emitting laser (VECSEL), etc . . . The term “light source” may also refer to an organic light-emitting diode (OLED), such as a passive-matrix (PMOLED) or an active-matrix (AMOLED). In a specific embodiment, the light source comprises a solid-state light source (such as an LED or laser diode). In an embodiment, the light source comprises an LED (light emitting diode). The terms “light source” or “solid state light source” may also refer to a superluminescent diode (SLED).

The term LED may also refer to a plurality of LEDs.

The term “light source” may also relate to a plurality of (essentially identical (or different)) light sources, such as 2-2000 solid state light sources. In embodiments, the light source may comprise one or more micro-optical elements (array of micro lenses) downstream of a single solid-state light source, such as an LED, or downstream of a plurality of solid-state light sources (i.e. e.g. shared by multiple LEDs). In embodiments, the light source may comprise an LED with on-chip optics. In embodiments, the light source comprises pixelated single LEDs (with or without optics) (offering in embodiments on-chip beam steering).

In embodiments, the light source may be configured to provide primary radiation, which is used as such, such as e.g. a blue light source, like a blue LED, or a green light source, such as a green LED, and a red light source, such as a red LED. Such LEDs, which may not comprise a luminescent material (“phosphor”) may be indicated as direct color LEDs.

In other embodiments, however, the light source may be configured to provide primary radiation and part of the primary radiation is converted into secondary radiation. Secondary radiation may be based on conversion by a luminescent material. The secondary radiation may therefore also be indicated as luminescent material radiation. The luminescent material may in embodiments be comprised by the light source, such as an LED with a luminescent material layer or dome comprising luminescent material. Such LEDs may be indicated as phosphor converted LEDs or PC LEDs (phosphor converted LEDs). In other embodiments, the luminescent material may be configured at some distance (“remote”) from the light source, such as an LED with a luminescent material layer not in physical contact with a die of the LED. Hence, in specific embodiments the light source may be a light source that during operation emits at least light at wavelength selected from the range of 380-470 nm. However, other wavelengths may also be possible. This light may partially be converted by the luminescent material.

In embodiments, the light generating device may comprise a luminescent material. In embodiments, the light generating device may comprise a PC LED. In other embodiments, the light generating device may comprise a direct LED (i.e. no phosphor). In embodiments, the light generating device may comprise a laser device, like a laser diode. In embodiments, the light generating device may comprise a superluminescent diode. Hence, in specific embodiments, the light source may be selected from the group of laser diodes and superluminescent diodes. In other embodiments, the light source may comprise an LED.

The light source may especially be configured to generate light source light having an optical axis (O), (a beam shape,) and a spectral power distribution. The light source light may in embodiments comprise one or more bands, having band widths as known for lasers.

The term “light source” may (thus) refer to a light generating element as such, like e.g. a solid state light source, or e.g. to a package of the light generating element, such as a solid state light source, and one or more of a luminescent material comprising element and (other) optics, like a lens, a collimator. A light converter element (“converter element” or “converter”) may comprise a luminescent material comprising element. For instance, a solid state light source as such, like a blue LED, is a light source. A combination of a solid state light source (as light generating element) and a light converter element, such as a blue LED and a light converter element, optically coupled to the solid state light source, may also be a light source (but may also be indicated as light generating device). Hence, a white LED is a light source (but may e.g. also be indicated as (white) light generating device).

The term “light source” herein may also refer to a light source comprising a solid state light source, such as an LED or a laser diode or a superluminescent diode.

The term “light source” may (thus) in embodiments also refer to a light source that is (also) based on conversion of light, such as a light source in combination with a luminescent converter material. Hence, the term “light source” may also refer to a combination of an LED with a luminescent material configured to convert at least part of the LED radiation, or to a combination of a (diode) laser with a luminescent material configured to convert at least part of the (diode) laser radiation.

In embodiments, the term “light source” may also refer to a combination of a light source, like an LED, and an optical filter, which may change the spectral power distribution of the light generated by the light source. Especially, the term “light generating device” may be used to address a light source and further (optical components), like an optical filter and/or a beam shaping element, etc.

The phrases “different light sources” or “a plurality of different light sources”, and similar phrases, may in embodiments refer to a plurality of solid-state light sources selected from at least two different bins. Likewise, the phrases “identical light sources” or “a plurality of same light sources”, and similar phrases, may in embodiments refer to a plurality of solid-state light sources selected from the same bin.

The term “solid state light source”, or “solid state material light source”, and similar terms, may especially refer to semiconductor light sources, such as a light emitting diode (LED), a laser diode, or a superluminescent diode.

The term “laser light source” especially refers to a laser. Such laser may especially be configured to generate laser light source light having one or more wavelengths in the UV, visible, or infrared, especially having a wavelength selected from the spectral wavelength range of 200-2000 nm, such as 300-1500 nm. The term “laser” especially refers to a device that emits light through a process of optical amplification based on the stimulated emission of electromagnetic radiation.

Especially, in embodiments the term “laser” may refer to a solid-state laser. In specific embodiments, the terms “laser” or “laser light source”, or similar terms, refer to a laser diode (or diode laser).

Hence, in embodiments the light source comprises a laser light source. In embodiments, the terms “laser” or “solid state laser” or “solid state material laser” may refer to one or more of cerium doped lithium strontium (or calcium) aluminum fluoride (Ce:LiSAF, Ce:LiCAF), chromium doped chrysoberyl (alexandrite) laser, chromium ZnSe (Cr:ZnSe) laser, divalent samarium doped calcium fluoride (Sm:CaF₂) laser, Er:YAG laser, erbium doped and erbium-ytterbium codoped glass lasers, F-Center laser, holmium YAG (Ho:YAG) laser, Nd:YAG laser, NdCrYAG laser, neodymium doped yttrium calcium oxoborate Nd:YCa₄O(BO₃)₃ or Nd:YCOB, neodymium doped yttrium orthovanadate (Nd:YVO₄) laser, neodymium glass (Nd:glass) laser, neodymium YLF (Nd:YLF) solid-state laser, promethium 147 doped phosphate glass (147Pm³⁺:glass) solid-state laser, ruby laser (Al₂O₃:Cr³⁺), thulium YAG (Tm:YAG) laser, titanium sapphire (Ti:sapphire; Al₂O₃:Ti³⁺) laser, trivalent uranium doped calcium fluoride (U:CaF₂) solid-state laser, Ytterbium doped glass laser (rod, plate/chip, and fiber), Ytterbium YAG (Yb:YAG) laser, Yb₂O₃ (glass or ceramics) laser, etc.

For instance, including second and third harmonic generation embodiments, the light source may comprise one or more of an F center laser, a yttrium orthovanadate (Nd:YVO₄) laser, a promethium 147 doped phosphate glass (147Pm³⁺:glass), and a titanium sapphire (Ti:sapphire; Al₂O₃:Ti³⁺) laser. For instance, considering second and third harmonic generation, such light sources may be used to generated blue light.

In embodiments, the terms “laser” or “solid state laser” or “solid state material laser” may refer to one or more of a semiconductor laser diodes, such as GaN, InGaN, AlGaInP, AlGaAs, InGaAsP, lead salt, vertical cavity surface emitting laser (VCSEL), quantum cascade laser, hybrid silicon laser, etc.

A laser may be combined with an upconverter in order to arrive at shorter (laser) wavelengths. For instance, with some (trivalent) rare earth ions upconversion may be obtained or with non-linear crystals upconversion can be obtained. Alternatively, a laser can be combined with a downconverter, such as a dye laser, to arrive at longer (laser) wavelengths.

As can be derived from the below, the term “laser light source” may also refer to a plurality of (different or identical) laser light sources. In specific embodiments, the term “laser light source” may refer to a plurality N of (identical) laser light sources. In embodiments, N=2, or more. In specific embodiments, N may be at least 5, such as especially at least 8. In this way, a higher brightness may be obtained. In embodiments, laser light sources may be arranged in a laser bank (see also above). The laser bank may in embodiments comprise heat sinking and/or optics e.g. a lens to collimate the laser light. Hence, in embodiments lasers in a laser bank (or “laser array bank”) may share the same optics.

The laser light source is configured to generate laser light source light (or “laser light”). The light source light may essentially consist of the laser light source light. The light source light may also comprise laser light source light of two or more (different or identical) laser light sources. For instance, the laser light source light of two or more (different or identical) laser light sources may be coupled into a light guide, to provide a single beam of light comprising the laser light source light of the two or more (different or identical) laser light sources. In specific embodiments, the light source light is thus especially collimated light source light. In yet further embodiments, the light source light is especially (collimated) laser light source light.

The laser light source light may in embodiments comprise one or more bands, having band widths as known for lasers. In specific embodiments, the band(s) may be relatively sharp line(s), such as having full width half maximum (FWHM) in the range of less than 20 nm at RT, such as equal to or less than 10 nm. Hence, the light source light has a spectral power distribution (intensity on an energy scale as function of the wavelength) which may comprise one or more (narrow) bands.

The beams (of light source light) may be focused or collimated beams of (laser) light source light. The term “focused” may especially refer to converging to a small spot. This small spot may be at the discrete converter region, or (slightly) upstream thereof or (slightly) downstream thereof. Especially, focusing and/or collimation may be such that the cross-sectional shape (perpendicular to the optical axis) of the beam at the discrete converter region (at the side face) is essentially not larger than the cross-section shape (perpendicular to the optical axis) of the discrete converter region (where the light source light irradiates the discrete converter region). Focusing may be executed with one or more optics, like (focusing) lenses. Especially, two lenses may be applied to focus the laser light source light. Collimation may be executed with one or more (other) optics, like collimation elements, such as lenses and/or parabolic mirrors. In embodiments, the beam of (laser) light source light may be relatively highly collimated, such as in embodiments ≤2° (FWHM), more especially ≤1° (FWHM), most especially ≤0.5° (FWHM). Hence, ≤2° (FWHM) may be considered (highly) collimated light source light. Optics may be used to provide (high) collimation (see also above).

The term “solid state material laser”, and similar terms, may refer to a solid state laser like based on a crystalline or glass body dopes with ions, like transition metal ions and/or lanthanide ions, to a fiber laser, to a photonic crystal laser, to a semiconductor laser, such as e.g. a vertical cavity surface-emitting laser (VCSEL), etc.

The term “solid state light source”, and similar terms, may especially refer to semiconductor light sources, such as a light emitting diode (LED), a laser diode, or a superluminescent diode.

Instead of the term “solid state light source” also the term “semiconductor-based light source” may be applied. Hence, the term “semiconductor-based light source” may e.g. refer to one or more of a light emitting diode (LED), a laser diode, and a superluminescent diode.

Hence, the light generating device may comprise one or more of a light emitting diode (LED), a laser diode, and a superluminescent diode.

A light-emitting diode (LED) is especially a semiconductor light source that emits light when current flows through it. Electrons in the semiconductor may recombine with electron holes, releasing energy in the form of photons. The color of the light (corresponding to the energy of the photons) may be determined by the energy required for electrons to cross the band gap of the semiconductor.

A laser diode (or diode laser) may be a semiconductor device substantially similar to a light-emitting diode in which a diode pumped directly with electrical current can create lasing conditions at the diode's junction. This is known to a person skilled in the art.

Superluminescent diodes are known in the art. A superluminescent diode may be indicated as a semiconductor device which may be able to emit low-coherence light of a broad spectrum like an LED, while having a brightness in the order of a laser diode.

US2020192017 indicates for instance that “With current technology, a single SLED is capable of emitting over a bandwidth of, for example, at most 50-70 nm in the 800-900 nm wavelength range with sufficient spectral flatness and sufficient output power. In the visible range used for display applications, i.e. in the 450-650 nm wavelength range, a single SLED is capable of emitting over bandwidth of at most 10-30 nm with current technology. Those emission bandwidths are too small for a display or projector application which requires red (640 nm), green (520 nm) and blue (450 nm), i.e. RGB, emission”. Further, superluminescent diodes are amongst others described, in “Edge Emitting Laser Diodes and Superluminescent Diodes”, Szymon Stanczyk, Anna Kafar, Dario Schiavon, Stephen Najda, Thomas Slight, Piotr Perlin, Book Editor(s): Fabrizio Roccaforte, Mike Leszczynski, First published: 3 Aug. 2020 https://doi.org/10.1002/9783527825264.ch9 in chapter 9.3 superluminescent diodes. This book, and especially chapter 9.3, are herein incorporated by reference. Amongst others, it is indicated therein that the superluminescent diode (SLD) is an emitter, which combines the features of laser diodes and light-emitting diodes. SLD emitters utilize the stimulated emission, which means that these devices operate at current densities similar to those of laser diodes. The main difference between LDs and SLDs is that in the latter case, the device waveguide may be designed in a special way preventing the formation of a standing wave and lasing. Still, the presence of the waveguide ensures the emission of a high-quality light beam with high spatial coherence of the light, but the light is characterized by low time coherence at the same time” and “Currently, the most successful designs of nitride SLD are bent, curved, or tilted waveguide geometries as well as tilted facet geometries, whereas in all cases, the front end of the waveguide meets the device facet in an inclined way, as shown in Figure 9.10. The inclined waveguide suppresses the reflection of light from the facet to the waveguide by directing it outside to the lossy unpumped area of the device chip”. Hence, an SLD may especially be a semiconductor light source, where the spontaneous emission light is amplified by stimulated emission in the active region of the device. Such emission is called “super luminescence”. Superluminescent diodes combine the high power and brightness of laser diodes with the low coherence of conventional light-emitting diodes. The low (temporal) coherence of the source has advantages that the speckle is significantly reduced or not visible, and the spectral distribution of emission is much broader compared to laser diodes, which can be better suited for lighting applications. Especially, with varying electrical current, the spectral power distribution of the superluminescent diode may vary. In this way the spectral power distribution can be controlled, see e.g. also Abdullah A. Alatawi, et al., Optics Express Vol. 26, Issue 20, pp. 26355-26364, https://doi.org/10.1364/OE.26.026355. Hence, a superluminescent diode may be indicated as a semiconductor device which may be able to emit low-coherence light of a broad spectrum like a LED, while having a brightness in the order of a laser diode. Superluminescent diodes may combine the high power and brightness of laser diodes with the low coherence of conventional light-emitting diodes. The low (temporal) coherence of the source has advantages that the speckle is significantly reduced or not visible, and the spectral distribution of emission is much broader compared to laser diodes, which can be better suited for lighting applications. Hence, in embodiments, the solid state light source may comprise a superluminescent diode. For instance, in further specific embodiments, the solid state light source may comprise a GaN-based superluminescent diode, or an InGaN-based superluminescent diode, or an AlGaN-based superluminescent diode.

Especially, in embodiments the first light generating device is configured to generate first device light. In specific embodiments, the device light may be blue light. The terms “blue light” or “blue emission”, and similar terms, may especially relate to light having a wavelength in the range of about 440-490 nm (including some violet and cyan hues). In specific embodiments, the blue light may have a centroid wavelength in the 440-490 nm range. Especially, the first device light has a first peak wavelength λ1. In specific embodiments, the first peak wavelength λ1 is selected from the blue wavelength range. In embodiments, the first device light may be unpolarized light. Further, in (other) embodiments the first device light may comprise one or more of polarized light having a p polarization and polarized light having an s polarization. Hence, in specific embodiments the first device light may be elliptically polarized. Optionally, the polarization of the first device light may be controllable, such as using one or more of (i) polarization control optics, and (ii) using two or more first light generating devices generating device light having different (linear or elliptical) polarizations. In embodiments, the first light generating device comprises a first light source selected from a laser diode and a superluminescent diode. Hence, especially the first light generating device comprises a solid state light source. More especially, the first device light is laser light.

Especially, in embodiments the second light generating device is configured to generate second device light. In specific embodiments, the device light may be blue light. Especially, the second device light has a second peak wavelength λ2. In specific embodiments, the second peak wavelength λ2 is selected from the blue wavelength range. Further, in embodiments the second device light may comprise one or more of polarized light having a p polarization and polarized light having an s polarization. Hence, in embodiments the second device light may be elliptically polarized. Optionally, the polarization of the second device light may be controllable, such as using one or more of (i) polarization control optics, and (ii) using two or more second light generating devices generating device light having different (linear or elliptical) polarizations. However, as indicated below, the polarization may especially (also) be controlled by the polarization control element. In embodiments, the second light generating device comprises a second light source selected from a laser diode and a superluminescent diode. Hence, especially the second light generating device comprises a solid state light source. More especially, the second device light is laser light. Herein, especially the second device light comprises-polarized light, whereas the first device light may comprise polarized light. Hence, the second device light as generated by the second light generating device may especially have a net polarization.

In embodiments, |λ1−λ2|≥3 nm, such as |λ1−λ2|≥4 nm|, more especially λ1−λ2|≥5 nm. More especially, |λ1−λ2|≥10 nm, or even |λ1−λ2|≥15 nm. Yet, in embodiments 10 nm≤|λ1−λ2|≤50 nm. In specific embodiments, the first peak wavelength may be selected at a spectral position of maximum absorption of the luminescent material, and the second peak wavelength thus at a position of at least 5 nm, more especially at least 10 nm, blue shifted or red shift, especially red shifted. Hence, in embodiments λ2>λ1. This may be useful in view of the use of the dichroic beam splitter used in the central optics (see also below). In other embodiments, the first peak wavelength may and the second peak wavelength may both be selected at a spectral position offset from maximum absorption of the luminescent material. For instance, one may be a blue shifted relative to the maximum absorption and the other one may be red shifted relative to the maximum absorption.

Assuming the use of laser, the difference between first peak wavelength and the second peak wavelength may be relatively small. Especially, the first peak wavelength and the second peak wavelength, and the first optics, may be selected such that the two peak wavelengths are spectrally positioned at two opposite sides of a cut-on/cut-off wavelength of a dichroic filter comprised by the first optics. Hence, the first peak wavelength and the second peak wavelength, and the first optics may be selected such, that the first optics may spectrally separate them, and essentially transmit one and essentially reflect the other.

Hence, the first device light and second device light may have different spectral power distributions and/or different color points. In specific embodiments, colors or color points of a first type of light and a second type of light may be different when the respective color points of the first type of light and the second type of light differ with at least 0.01 for u′ and/or with at least 0.01 for v′, even more especially at least 0.02 for u′ and/or with at least 0.02 for v′. In yet more specific embodiments, the respective color points of first type of light and the second type of light may differ with at least 0.03 for u′ and/or with at least 0.03 for v′. Here, u′ and v′ are color coordinates of the light in the CIE 1976 UCS (uniform chromaticity scale) diagram. Spectral power distributions of different sources of light having centroid wavelengths differing at least 10 nm, such as at least 20 nm, or even at least 30 nm may be considered different spectral power distributions, e.g. different colors. In general, the differences in centroid wavelengths will not be larger than about 400 nm, such as not more than 350 nm. Note that for the first device light and the second device light, the differences in centroid wavelengths may be relatively small, such as selected from the range of 3-50 nm, such as selected from the range of 5-50 nm, like selected from the range of 5-40 nm. Hence, in embodiments the difference in centroid wavelength of the first device light and second device light herein may in embodiments be not larger than about 50 nm.

Further, the light generating system comprises a luminescent material. The term “luminescent material” especially refers to a material that can convert first radiation, especially one or more of UV radiation and blue radiation, into second radiation. In general, the first radiation and second radiation have different spectral power distributions. Hence, instead of the term “luminescent material”, also the terms “luminescent converter” or “converter” may be applied. In general, the second radiation has a spectral power distribution at larger wavelengths than the first radiation, which is the case in the so-called down-conversion. In specific embodiments, however the second radiation has a spectral power distribution with intensity at smaller wavelengths than the first radiation, which is the case in the so-called up-conversion.

In embodiments, the “luminescent material” may especially refer to a material that can convert radiation into e.g. visible and/or infrared light. For instance, in embodiments the luminescent material may be able to convert one or more of UV radiation and blue radiation, into visible light. The luminescent material may in specific embodiments also convert radiation into infrared radiation (IR). Hence, upon excitation with radiation, the luminescent material emits radiation. In general, the luminescent material will be a down converter, i.e. radiation of a smaller wavelength is converted into radiation with a larger wavelength (λₑₓ<λₑₘ), though in specific embodiments the luminescent material may comprise up-converter luminescent material, i.e. radiation of a larger wavelength is converted into radiation with a smaller wavelength (λₑₓ>λₑₘ).

In embodiments, the term “luminescence” may refer to phosphorescence. In embodiments, the term “luminescence” may also refer to fluorescence. Instead of the term “luminescence”, also the term “emission” may be applied. Hence, the terms “first radiation” and “second radiation” may refer to excitation radiation and emission (radiation), respectively. Likewise, the term “luminescent material” may in embodiments refer to phosphorescence and/or fluorescence.

The term “luminescent material” may also refer to a plurality of different luminescent materials. Examples of possible luminescent materials are indicated below. Hence, the term “luminescent material” may in specific embodiments also refer to a luminescent material composition. Instead of the term “luminescent material” also the term “phosphor” may be applied. These terms are known to the person skilled in the art.

In embodiments, luminescent materials are selected from garnets and nitrides, especially doped with trivalent cerium or divalent europium, respectively. The term “nitride” may also refer to oxynitride or nitridosilicate, etc. Alternatively or additionally, the luminescent material(s) may be selected from silicates, especially doped with divalent europium.

In specific embodiments the luminescent material comprises a luminescent material of the type A₃B₅O₁₂:Ce, wherein A in embodiments comprises one or more of Y, La, Gd, Tb and Lu, especially (at least) one or more of Y, Gd, Tb and Lu, and wherein B in embodiments comprises one or more of Al, Ga, In and Sc. Especially, A may comprise one or more of Y, Gd and Lu, such as especially one or more of Y and Lu. Especially, B may comprise one or more of Al and Ga, more especially at least Al, such as essentially entirely Al. Hence, especially suitable luminescent materials are cerium comprising garnet materials. Embodiments of garnets especially include A₃B₅O₁₂ garnets, wherein A comprises at least yttrium or lutetium and wherein B comprises at least aluminum. Such garnets may be doped with cerium (Ce), with praseodymium (Pr) or a combination of cerium and praseodymium; especially however with Ce. Especially, B may comprise aluminum (Al); however, in addition to aluminum, B may also partly comprise gallium (Ga) and/or scandium (Sc) and/or indium (In), especially up to about 20% of B, more especially up to about 10 % of B (i.e. the B ions essentially consist of 90 or more mole % of Al and 10 or less mole % of one or more of Ga, Sc and In); B may especially comprise up to about 10% gallium. In another variant, B and O may at least partly be replaced by Si and N. The element A may especially be selected from the group consisting of yttrium (Y), gadolinium (Gd), terbium (Tb) and lutetium (Lu). Further, Gd and/or Tb are especially only present up to an amount of about 20% of A. In a specific embodiment, the garnet luminescent material comprises (Y₁₋ₓLuₓ)₃B₅O₁₂:Ce, wherein x is equal to or larger than 0 and equal to or smaller than 1. The term “:Ce”, indicates that part of the metal ions (i.e. in the garnets: part of the “A” ions) in the luminescent material is replaced by Ce. For instance, in the case of (Y₁₋ₓLuₓ)₃Al₅O₁₂:Ce, part of Y and/or Lu is replaced by Ce. This is known to the person skilled in the art. Ce will replace A in general for not more than 10%; in general, the Ce concentration will be in the range of 0.1 to 4%, especially 0.1 to 2% (relative to A). Assuming 1% Ce and 10% Y, the full correct formula could be (Y_{0.1}Lu_{0.89}Ce_{0.01})₃Al₅O₁₂. Ce in garnets is substantially or only in the trivalent state, as is known to the person skilled in the art.

In embodiments, the luminescent material (thus) comprises A₃B₅O₁₂ wherein in specific embodiments at maximum 10% of B—O may be replaced by Si—N.

In specific embodiments the luminescent material comprises (Yₓ₁A′ₓ₂Ceₓ₃)₃(Al_{y1}B′_{y2})₅O₁₂, wherein x1+x2+x3=1, wherein x3>0, wherein 0<x2+x3≤0.2, wherein y1+y2=1, wherein especially 0≤y2≤0.2, wherein A′ comprises one or more elements selected from the group consisting of lanthanides, and wherein B′ comprises one or more elements selected from the group consisting of Ga, In and Sc. In embodiments, x3 is selected from the range of 0.001-0.1. In the present invention, especially x1>0, such as >0.2, like at least 0.8. Garnets with Y may provide suitable spectral power distributions.

In specific embodiments at maximum 10% of B—O may be replaced by Si—N. Here, B in B—O refers to one or more of Al, Ga, In and Sc (and O refers to oxygen); in specific embodiments B—O may refer to Al—O. As indicated above, in specific embodiments x3 may be selected from the range of 0.001-0.04. Especially, such luminescent materials may have a suitable spectral distribution (see however below), have a relatively high efficiency, have a relatively high thermal stability, and allow a high CRI (optionally in combination with (the) light of other sources of light as described herein). Hence, in specific embodiments A may be selected from the group consisting of Lu and Gd. Alternatively or additionally, B may comprise Ga. Hence, in embodiments the luminescent material comprises (Yₓ₁(Lu,Gd)ₓ₂Ceₓ₃)₃(Al_{y1}Ga_{y2})₅O₁₂, wherein Lu and/or Gd may be available. Even more especially, x3 is selected from the range of 0.001-0.1, wherein 0<x2+x3≤0.1, and wherein 0≤y2≤0.1. Further, in specific embodiments, at maximum 1% of B—O may be replaced by Si—N. Here, the percentage refers to moles (as known in the art); see e.g. also EP3149108. In yet further specific embodiments, the luminescent material comprises (Yₓ₁Ceₓ₃)₃Al₅O₁₂, wherein x1+x3=1, and wherein 0<x3≤0.2, such as 0.001-0.1.

In specific embodiments, the light generating device may only include luminescent materials selected from the type of cerium comprising garnets. In even further specific embodiments, the light generating device includes a single type of luminescent materials, such as (Yₓ₁A′ₓ₂Ceₓ₃)₃(Al_{y1}B′_{y2})₅O₁₂. Hence, in specific embodiments the light generating device comprises luminescent material, wherein at least 85 weight %, even more especially at least about 90 wt. %, such as yet even more especially at least about 95 weight % of the luminescent material comprises (Yₓ₁A′ₓ₂Ceₓ₃)₃(Al_{y1}B′_{y2})₅O₁₂. Here, wherein A′ comprises one or more elements selected from the group consisting of lanthanides, and wherein B′ comprises one or more elements selected from the group consisting of Ga, In and Sc, wherein x1+x2+x3=1, wherein x3>0, wherein 0<x2+x3≤0.2, wherein y1+y2=1, wherein 0≤y2≤0.2. Especially, x3 is selected from the range of 0.001-0.1. Note that in embodiments x2=0. Alternatively or additionally, in embodiments y2=0.

In specific embodiments, A may especially comprise at least Y, and B may especially comprise at least Al.

Alternatively or additionally, the luminescent material may comprise a luminescent material of the type A₃Si₆N₁₁:Ce³⁺, wherein A comprises one or more of Y, La, Gd, Tb and Lu, such as in embodiments one or more of La and Y.

In embodiments, the luminescent material may alternatively or additionally comprise one or more of MS:Eu²⁺ and/or M₂Si₅N₈:Eu²⁺ and/or MAlSiN₃:Eu²⁺ and/or Ca₂AlSi₃O₂N₅:Eu²⁺, etc., wherein M comprises one or more of Ba, Sr and Ca, especially in embodiments at least Sr. Hence, in embodiments, the luminescent may comprise one or more materials selected from the group consisting of (Ba,Sr,Ca)S:Eu, (Ba,Sr,Ca)AlSiN₃:Eu and (Ba,Sr,Ca)₂Si₅N₈:Eu. In these compounds, europium (Eu) is substantially or only divalent, and replaces one or more of the indicated divalent cations. In general, Eu will not be present in amounts larger than 10% of the cation; its presence will especially be in the range of about 0.5 to 10%, more especially in the range of about 0.5 to 5% relative to the cation(s) it replaces. The term “:Eu”, indicates that part of the metal ions is replaced by Eu (in these examples by Eu²⁺). For instance, assuming 2% Eu in CaAlSiN₃:Eu, the correct formula could be (Ca_{0.98}Eu_{0.02})AlSiN₃. Divalent europium will in general replace divalent cations, such as the above divalent alkaline earth cations, especially Ca, Sr or Ba. The material (Ba,Sr,Ca)S:Eu can also be indicated as MS:Eu, wherein M is one or more elements selected from the group consisting of barium (Ba), strontium (Sr) and calcium (Ca); especially, M comprises in this compound calcium or strontium, or calcium and strontium, more especially calcium. Here, Eu is introduced and replaces at least part of M (i.e. one or more of Ba, Sr, and Ca). Further, the material (Ba,Sr,Ca)₂Si₅N₈:Eu can also be indicated as M₂Si₅N₈:Eu, wherein M is one or more elements selected from the group consisting of barium (Ba), strontium (Sr) and calcium (Ca); especially, M comprises in this compound Sr and/or Ba. In a further specific embodiment, M consists of Sr and/or Ba (not taking into account the presence of Eu), especially 50 to 100%, more especially 50 to 90% Ba and 50 to 0%, especially 50 to 10% Sr, such as Ba_{1.5}Sr_{0.5}Si₅N₈:Eu (i.e. 75 % Ba; 25% Sr). Here, Eu is introduced and replaces at least part of M, i.e. one or more of Ba, Sr, and Ca). Likewise, the material (Ba,Sr,Ca)AlSiN₃:Eu can also be indicated as MAlSiN₃:Eu, wherein M is one or more elements selected from the group consisting of barium (Ba), strontium (Sr) and calcium (Ca); especially, M comprises in this compound calcium or strontium, or calcium and strontium, more especially calcium. Here, Eu is introduced and replaces at least part of M (i.e. one or more of Ba, Sr, and Ca). Eu in the above indicated luminescent materials is substantially or only in the divalent state, as is known to the person skilled in the art.

In embodiments, a red luminescent material may comprise one or more materials selected from the group consisting of (Ba,Sr,Ca)S:Eu, (Ba,Sr,Ca)AlSiN₃:Eu and (Ba,Sr,Ca)₂Si₅N₈:Eu. In these compounds, europium (Eu) is substantially or only divalent, and replaces one or more of the indicated divalent cations. In general, Eu will not be present in amounts larger than 10% of the cation; its presence will especially be in the range of about 0.5 to 10%, more especially in the range of about 0.5 to 5% relative to the cation(s) it replaces. The term “:Eu”, indicates that part of the metal ions is replaced by Eu (in these examples by Eu²⁺). For instance, assuming 2% Eu in CaAlSiN₃:Eu, the correct formula could be (Ca_{0.98}Eu_{0.02})AlSiN₃. Divalent europium will in general replace divalent cations, such as the above divalent alkaline earth cations, especially Ca, Sr or Ba.

The material (Ba,Sr,Ca)S:Eu can also be indicated as MS:Eu, wherein M is one or more elements selected from the group consisting of barium (Ba), strontium (Sr) and calcium (Ca); especially, M comprises in this compound calcium or strontium, or calcium and strontium, more especially calcium. Here, Eu is introduced and replaces at least part of M (i.e. one or more of Ba, Sr, and Ca).

Further, the material (Ba,Sr,Ca)₂Si₅N₈:Eu can also be indicated as M₂Si₅N₈:Eu, wherein M is one or more elements selected from the group consisting of barium (Ba), strontium (Sr) and calcium (Ca); especially, M comprises in this compound Sr and/or Ba. In a further specific embodiment, M consists of Sr and/or Ba (not taking into account the presence of Eu), especially 50 to 100%, more especially 50 to 90% Ba and 50 to 0%, especially 50 to 10% Sr, such as Ba_{1.5}Sr_{0.5}Si₅N₈:Eu (i.e. 75% Ba; 25% Sr). Here, Eu is introduced and replaces at least part of M, i.e. one or more of Ba, Sr, and Ca).

Likewise, the material (Ba,Sr,Ca)AlSiN₃:Eu can also be indicated as MAlSiN₃:Eu, wherein M is one or more elements selected from the group consisting of barium (Ba), strontium (Sr) and calcium (Ca); especially, M comprises in this compound calcium or strontium, or calcium and strontium, more especially calcium. Here, Eu is introduced and replaces at least part of M (i.e. one or more of Ba, Sr, and Ca).

Eu in the above indicated luminescent materials is substantially or only in the divalent state, as is known to the person skilled in the art.

Blue luminescent materials may comprise YSO (Y₂SiO₅:Ce³⁺), or similar compounds, or BAM (BaMgAl₁₀O₁₇:Eu²⁺), or similar compounds.

The term “luminescent material” herein especially relates to inorganic luminescent materials.

Alternatively or additionally, also other luminescent materials may be applied. For instance quantum dots and/or organic dyes may be applied and may optionally be embedded in transmissive matrices like e.g. polymers, like PMMA, or polysiloxanes, etc. etc.

Quantum dots are small crystals of semiconducting material generally having a width or diameter of only a few nanometers. When excited by incident light, a quantum dot emits light of a color determined by the size and material of the crystal. Light of a particular color can therefore be produced by adapting the size of the dots. Most known quantum dots with emission in the visible range are based on cadmium selenide (CdSe) with a shell such as cadmium sulfide (CdS) and zinc sulfide (ZnS). Cadmium free quantum dots such as indium phosphide (InP), and copper indium sulfide (CuInS₂) and/or silver indium sulfide (AgInS₂) can also be used. Quantum dots show very narrow emission band and thus they show saturated colors. Furthermore the emission color can easily be tuned by adapting the size of the quantum dots. Any type of quantum dot known in the art may be used in the present invention. However, it may be preferred for reasons of environmental safety and concern to use cadmium-free quantum dots or at least quantum dots having a very low cadmium content.

Instead of quantum dots or in addition to quantum dots, also other quantum confinement structures may be used. The term “quantum confinement structures” should, in the context of the present application, be understood as e.g. quantum wells, quantum dots, quantum rods, tripods, tetrapods, or nanowires, etcetera.

Organic phosphors can be used as well. Examples of suitable organic phosphor materials are organic luminescent materials based on perylene derivatives, for example compounds sold under the name Lumogen® by BASF. Examples of suitable compounds include, but are not limited to, Lumogen® Red F305, Lumogen® Orange F240, Lumogen® Yellow F083, and Lumogen® F170.

Different luminescent materials may have different spectral power distributions of the respective luminescent material light. Alternatively or additionally, such different luminescent materials may especially have different color points (or dominant wavelengths).

As indicated above, other luminescent materials may also be possible. Hence, in specific embodiments the luminescent material is selected from the group of divalent europium containing nitrides, divalent europium containing oxynitrides, divalent europium containing silicates, cerium comprising garnets, and quantum structures. Quantum structures may e.g. comprise quantum dots or quantum rods (or other quantum type particles) (see above). Quantum structures may also comprise quantum wells. Quantum structures may also comprise photonic crystals.

In embodiments, the luminescent material may at least comprise a luminescent material of the type A₃B₅O₁₂:Ce, wherein A comprises one or more of Y, La, Gd, Tb and Lu, and wherein B comprises one or more of Al, Ga, In and Sc.

In specific embodiments, the luminescent material may comprise at least two different luminescent materials configured to provide luminescent material light having different spectral power distributions. As can be derived from the above, the term “different luminescent materials” may refer to luminescent materials that are different, or to two compositions, each including at least one luminescent material in common, but wherein the compositions differ. For instance, a first luminescent material comprising luminescent materials A and B, and a second luminescent material comprising only A or only B, or comprising both A and B, but in a different weight ratio. Such first luminescent material and second luminescent material may have different spectral power distributions of their respective luminescent material light.

The luminescent material may be configured in the system such that, together with optics, first device light and/or second device light may reach the luminescent material. More especially, at least part of the first device light and (optionally) at least part of the second device light reaches the luminescent material. Especially, the luminescent material may be configured in the system such that, together with optics, at least first device light may irradiate the luminescent material. Whether the second device light irradiates the luminescent material may in embodiments depend e.g. on its polarization (see also below). Hence, the luminescent material, the first device, and the second device are selected such that the luminescent material is in principle able to convert at least part of the first device light and/or at least part of the second device light. In embodiments, the luminescent material may have an excitation band, especially in the blue wavelength range, having an excitation wavelength range defined by the full width half maximum of the excitation band, wherein the first wavelength λ1 and the second wavelength λ2 are within the excitation wavelength. Therefore, in embodiments the luminescent material may be configured to convert first device light and/or second device light received by the luminescent material into luminescent material light. More especially, in embodiments during operation the luminescent material may convert first device light received by the luminescent material into luminescent material light and optionally second device light, when received by the luminescent material, into luminescent material light. Whether second device light may be received by the luminescent material may depend upon its polarization (and the central optics).

Especially, the first device may be configured to irradiate the luminescent material, and thereby generate luminescent material light, and the second device may be configured to irradiate the diffuser element, and thereby generate diffused second device light. Hence, in embodiments in the system light, more than 50% of the spectral power in the blue wavelength range, may be provided by the second light generating device, such as at least 60%, more especially at least about 70%, like even at least 90%. Alternatively or additionally, more than 50% of the spectral power of the luminescent material light may be due to irradiation of the luminescent material by the first light generating device, such as at least 60%, more especially at least about 70%. However, other values may also be possible.

As can be derived from the above, the system may comprise a plurality of optics. Some optics may not (further) be described in detail and will be obvious to a person skilled in the art. Some optics, however, are described in further detail here below.

First optics may especially be used to route the first device light, the luminescent material light, and the second device light. The first device light and optionally the second device light may especially reach the luminescent material, and at least part of the luminescent material light may be able to escape from the system. For this purpose, the first optics may—amongst others—be applied. Especially, the first optics may be configured (a) to transmit or reflect at least part of the first device light, and (b) to reflect or transmit at least part of the luminescent material light. Hence, following propagation of the first device light from the first device, it may propagate—amongst others—via the first optics to the luminescent material. Following the propagation of the second device light from the second device, it may propagate—amongst others—via the first optics (and the central optics; see below) to the luminescent material. When irradiating the luminescent material, at least part of the first device light and/or at least part of the second device light may be converted into luminescent material light. Following the propagation of the luminescent material light from the luminescent material, it may propagate—amongst others—via the first optics (and the central optics; see below) to the external of the system. In specific embodiments, the first optics may comprise a first dichroic beam splitter, wherein the first dichroic beam splitter is especially configured (a) to transmit or reflect at least part of the first device light, and (b) to reflect or transmit at least part of the luminescent material light. Examples of such dichroic beam splitter are e.g. a short-pass cut-off dichroic plate, or a long-pass cut-off dichroic plate. In specific embodiments, the first dichroic beam splitter is designed for a 45° angle of incidence (of the first device light and/or second device light).

Downstream of the second light generating device, the polarization control may be configured. With the polarization control element, the polarization of the second device light may be controlled. For instance, with a (rotatable) λ/2 retarder (see also below), in embodiments polarizations between fully s polarization and fully p polarization may be chosen. In this way, the ratio between the second device light that is directed via the central optics to the diffuser element and second device light that is directed via the central optics to the luminescent material may be controlled. Note that in embodiments in some operational modes, essentially all second device light may be directed via the central optics to the diffuser element. In embodiments, in some other operational modes, essentially all second device light may be directed via the central optics to luminescent material. Yet, in embodiments in other operational modes, part of the second device light may be directed via the central optics to diffuser element and part of the second device light may be directed via the central optics to the luminescent material. Hence, (a) the polarization control element may be used to control the ratio of the polarizations of the second device light, and (downstream thereof) the central optics routes, dependent upon the polarization of the second device light, the further propagation of the second device light (see further also below).

Hence, in embodiments the polarization control element may especially be configured to control polarization of the second device light. In embodiments, the polarization control element may especially be configured to control a degree of polarization of the polarized light.

Especially, in embodiments the degree of polarization may be defined as a percentage of the p-polarized light or the s-polarized light relative to the total of s-polarized light and p-polarized light. For determining the percentages, the angular luminance of the second device light having s polarization and the angular luminance of the second device light having p polarization may be applied. For instance, the second device light, downstream of the polarization control element, may have 20% s polarization and 80% p polarization. For the angular luminance, see e.g. Blom, S. et al., Towards a polarized light-emitting backlight: Micro-structured anisotropic layers, DOI-10.1889/1.1827869, Journal of the Society for Information Display, September 2002, p. 209-213. Instead of the angular luminance, also the luminance may be applied.

Yet, (in general) the term “degree of polarization” is known in the art. Especially, in embodiments the degree of polarization may be defined as a percentage of the p-polarized light and/or the s-polarized light relative to the total of p-polarized light and s-polarized light. Measurement of the degree of polarization is known in the art, and may be based on Stokes parameters.

In embodiments, by rotating the polarization control element the polarization of the second device light may be controlled. As indicated herein, especially the second device light, upstream of the polarization control element, may be linearly polarized, like s-polarized or p-polarized. Optionally, the second device light may be a combination of s-polarized light and p-polarized light. For instance, with the polarization control element (by rotation the polarization control element), the combination of polarization control element and second light source may provide second device light, downstream of the polarization control element, having at least two polarizations selected from: essentially p-polarized, essentially s-polarized, and a combination of p-polarized and s-polarized. Note that in embodiments by rotating the polarization control element, a ratio between p-polarized and s-polarized may be controlled. For instance, would the second device light be p-polarized light, by rotating the polarization control element, the contribution of p-polarized light may be reduced and the contribution of s-polarized may be increased, until essentially s-polarized light is obtained. Hence, in dependence of the rotational angle, the polarization of the second device light may be controlled. In embodiments, a degree of polarization of the second device light may be controlled by the polarization control element. The system may comprise an actuator configured to control the polarization control element. The control system may control the actuator for controlling the polarization control element. In embodiments, the afore-mentioned angle may be fixed during operation (i.e. not controllable during operation), and in other embodiments, this angle may be controlled (by the control system). Especially, herein the polarization of the second device light propagating to the central optics is controllable (with the polarization control element). Especially, rotation of the polarization control element may imply rotation of the rotator axis. As further indicated below, the polarization control element may comprise a birefringent rotator.

Especially, instead of the term “s-polarized light”, and similar terms, also the term “linear s-polarized light” may be applied. Further, especially, instead of the term “p-polarized light”, and similar terms, also the term “linear p-polarized light” may be applied.

Dependent upon the polarization of the second device light, at least part of the second device light may be directed, via the central optics, to the diffuser element. More especially, it is directed via the central optics, and via the polarization changing element, to the diffuser element. At least part of the second device light that reaches the diffuser element will be diffused. The diffuser element, however, may maintain at least part of the polarization. Hence, in embodiments the diffuser element is especially configured to diffuse (by reflection) at least part of the second device light received by the diffuser element thereby providing diffused second device light while maintaining at least part of the polarization of the second device light. An example of such diffuser element is a metallic coated glass diffuser showing 95-98% reflectance. Further, in embodiments essentially no first device light may reach the diffuser element. Hence, especially the diffuser element may be configured to diffuse (by reflection) at least part of the second device light received by the diffuser element thereby providing diffused second device light while maintaining at least part of the polarization of the second device light.

As indicated above, a polarization changing element may be configured between the central optics and the diffuser element. Especially, the polarization changing element is configured to change s-polarized light or p-polarized light to circular polarized light. The diffuser element may change the direction of the polarized light, but the circular polarized light may essentially stay circular polarized light. At least part of the diffused light, having circular polarization, will propagate from the diffuser element to the polarization changing element, and then be converted to (diffused) s-polarized light and/or (diffused) p-polarized light, which may further propagate to the central optics. Therefore, in embodiments the polarization changing element may comprise a λ/4 waveplate; wherein the polarization changing element is especially configured in an optical path of the second device light between the central optics and the diffuser element. In this way, p-polarized light can be converted in diffused s-polarized light, and s-polarized light can be converted in diffused p-polarized light.

Especially, the polarization changing element may be an element that induces a 90° phase shift between the two orthogonal linear polarization components (s and p) of the light. The most common way is to use birefringent material (birefringent rotators), such as a quarter-wave plate. An alternative may be to use the Faraday effect, in which case the phase shift is caused by an applied magnetic field (Faraday rotators).

As indicated above, the system may comprise central optics. The term “central optics” is applied as essentially all light, i.e. the first device light, the diffused 2^{nd} device light, and the luminescent material light may only escape from the system via the central optics. Further, the second device light may only reach the diffuser element or the luminescent material via the central optics. In embodiments, the central optics comprises (i) a central optics polarizing beam splitter, and (ii) a central optics dichroic beam splitter. Hence, the term “central optics polarizing beam splitter” refers to a polarizing beam splitter comprised by the central optics. Likewise, the term “central optics dichroic beam splitter” refers to a dichroic beam splitter comprised by the central optics.

In specific embodiments, the central optics polarizing beam splitter may be configured to transmit and/or reflect at least part of the second device light in dependence of its polarization. Further, in specific embodiments the central optics dichroic beam splitter may be configured to (a) to transmit or reflect at least part of the second device light, and (b) to reflect or transmit at least part of the luminescent material light. Especially, the central optics polarizing beam splitter, and the central optics dichroic beam splitter are configured such that at least part of the diffused second device light reaching the central optics, and at least part of the luminescent material light reaching the central optics may escape from the system in essentially the same directions. Especially, this may imply that one of the diffused second device light and the luminescent material light is transmitted by the central optics and the other one of the diffused second device light and the luminescent material light is reflected by the central optics. Hence, the system may especially be configured such that diffused second device light propagating to the central optics and luminescent material light propagating to the central optics have a mutual angle of (about) 90°.

In specific embodiments, the second dichroic beam splitter is designed for 45° angle of incidence of at least the second device light.

Yet, in specific embodiments, the central optics polarizing beam splitter is designed for 45° angle of incidence of at least the second device light.

Hence, the central optics may comprise at least two different functionalities, which may e.g. be realized by using two optical components, or by using a single optical component with two different functional layers (or sets of layers) (e.g. surface configurations or coatings/dichroic layer stacks; or by integration of both functions in a single surface layer or coating (stack of dichroic layers)). Therefore, in embodiments, the central optics may comprise a single optical component having polarizing beam splitting functionality and dichroic beam splitting functionality, or comprises two optical components, one having polarizing beam splitting functionality and one having dichroic beam splitting functionality.

Especially, in embodiments, second device light reaching the central optics may be reflected and/or transmitted by the central optics polarizing beam splitter. Especially, (a) the polarization of the second device light and (b) the central optics polarizing beam splitter may be configured such that (i) at least part of the second device light propagates to the diffuser element (and is diffused at the diffuser elements), and (ii) at least part of the diffused second device light may escape from the system via the central optics. This may e.g. imply that the central optics polarizing beam splitter is at least partially transmissive for a first polarization and at least partially reflective for a second polarization, or, the other way around, this may e.g. imply that the central optics polarizing beam splitter is at least partially transmissive for a second polarization and at least partially transmissive for a second polarization.

As indicated above, the system may especially be configured such that diffused second device light propagating to the central optics and luminescent material light propagating to the central optics have a mutual angle of (about) 90°. Hence, in embodiments luminescent material light reaching the central optics may be reflected or transmitted at the central optics dichroic beam splitter. The central optics dichroic beam splitter may be configured such that (a) diffused second device light may be reflected at the central optics dichroic beam splitter when the central optics dichroic beam splitter is configured to transmit the luminescent material light, and/or (b) diffused second device light may be transmitted at the central optics dichroic beam splitter when the central optics dichroic beam splitter is configured to reflect the luminescent material light. Therefore, in embodiments the system may especially be configured such that diffused second device light and luminescent material light propagating orthogonal to the central optics may escape (in the same direction) from the system via the central optics to provide system light comprising the diffused second device light and luminescent material light. System light may escape from a light exit of the system (see also above).

Especially, the second peak wavelength and the luminescent material may be selected such that the peak wavelength of the second device light and the centroid wavelength of the luminescent material light are spectrally positioned at two opposite sides of a cut-on/cut-off wavelength of a dichroic filter comprised by the central optics. Hence, the second peak wavelength and the centroid wavelength of the luminescent material, may be selected such, that the central optics dichroic beam splitter may spectrally substantially separate them, and essentially transmit one and essentially reflect the other.

Especially, in specific embodiments the light generating system may be configured to provide system light comprising one or more of diffused second device light and luminescent material light. Further, especially the light generating system may be configured such that in a first operational mode of the light generating system (a) at least part of the first device light irradiates the luminescent material via the first optics, and the (thus generated) luminescent material light escapes from the light generating system via the first optics and the central optics, and (b) at least part of the second device light irradiates the diffuser element via the central optics, and at least part of the (thus generated) diffused second device light escapes from the light generating system (also) via the central optics. Note that in specific embodiments in the first operational mode at least part of the second device light (also) irradiates the luminescent material via the central optics, and at least part of the (thus generated) luminescent material light (also) escapes from the light generating system (also) via the central optics. As will be further explained below, there may only be the first operational mode, and in other embodiments there may be a plurality of (first) operational modes. In embodiments, the system light may comprise essentially no first device light.

In embodiments, the first device light and the second device light may have a wavelength selected from the blue wavelength range (see also above), more especially have peak wavelengths selected from the blue wavelength range, and in further specific embodiments the luminescent material light has a wavelength selected from the green-red wavelength range, and in yet further specific embodiments the system light in the first operational mode is white light. Here, the term “green-red wavelength range” may especially refer to the entire wavelength range green and red, and all wavelengths in between, i.e. 490-780 nm. Especially, the luminescent material may have a centroid wavelength selected from the green-red wavelength range.

Herein, the terms “violet light” or “violet emission”, and similar terms, may especially relate to light having a wavelength in the range of about 380-440 nm. In specific embodiments, the violet light may have a centroid wavelength in the 380-440 nm range. The terms “green light” or “green emission”, and similar terms, may especially relate to light having a wavelength in the range of about 490-560 nm. In specific embodiments, the green light may have a centroid wavelength in the 490-560 nm range. The terms “yellow light” or “yellow emission”, and similar terms, may especially relate to light having a wavelength in the range of about 560-590 nm. In specific embodiments, the yellow light may have a centroid wavelength in the 560-590 nm range. The terms “orange light” or “orange emission”, and similar terms, may especially relate to light having a wavelength in the range of about 590-620 nm. In specific embodiments, the orange light may have a centroid wavelength in the 590-620 nm range. The terms “red light” or “red emission”, and similar terms, may especially relate to light having a wavelength in the range of about 620-750 nm. In specific embodiments, the red light may have a centroid wavelength in the 620-750 nm range. The terms “cyan light” or “cyan emission”, and similar terms, especially relate to light having a wavelength in the range of about 490-520 nm. In specific embodiments, the cyan light may have a centroid wavelength in the 490-520 nm range. The terms “amber light” or “amber emission”, and similar terms, may especially relate to light having a wavelength in the range of about 585-605 nm, such as about 590-600 nm. In specific embodiments, the amber light may have a centroid wavelength in the 585-605 nm range. The phrase “light having one or more wavelengths in a wavelength range” and similar phrases may especially indicate that the indicated light (or radiation) has a spectral power distribution with at least intensity or intensities at these one or more wavelengths in the indicate wavelength range. For instance, a blue emitting solid state light source will have a spectral power distribution with intensities at one or more wavelengths in the 440-495 nm wavelength range.

In embodiments, the polarization control element may comprise a rotatable birefringent rotator. More especially, the (rotatable) birefringent rotator comprises a λ/2 waveplate.

However, other phase-shift inducing components for the two linear orthogonal polarization components which can change the ratio of transmitted versus reflected light may also be applied. With a half-wavelength plate, s-polarized light can be transformed for 0-100% into p-polarized light. With a quarter-wavelength plate that may be only 0-50%. With a ⅜th-wavelength plate 0-75%, and with a ⅛th-wavelength plate 0-25%. So, a half-wavelength plate may give full flexibility (and independence of the actual polarization direction of the source), while the other options may give more limitations, both in terms of the fraction of light that can be transformed into required polarized components and in terms of the orientation of the polarization direction of the source.

In specific embodiments, the polarization control element may be configured fixed. In such embodiments, essentially only a (single) first operational mode may be available, unless other parameters are variable (like the polarization of the second device light reaching the polarization control element, and/or the radiant flux of the first device light, and/or the radiant flux of the second device light). In other embodiments, the polarization control element may be configured controllable, especially rotatable. In such embodiments, by rotating the polarization control element, the spectral power distribution of the system light may be controlled. In such embodiments, a plurality of first operational modes may be available, with different spectral power distributions.

In specific embodiments, the light generating system may further comprise a control system, wherein the control system is configured to control a spectral power distribution of the system light by controlling one or more of (i) the polarization control element, (ii) a radiant flux of the first device light, and (iii) a radiant flux of the second device light. For instance, by increasing the radiant flux of the first device light relative to the second device light, the system light may have a larger contribution of the luminescent material light (and may e.g. have a lower correlated color temperature (CCT)). For instance, by increasing the radiant flux of the second device light relative to the first device light, the system light may have a larger contribution of the second device light (and may e.g. have a higher CCT). Further, by controlling the polarization of the second device light with the polarization control element, a ratio of the second device light ending up as diffused second device light in the system light and second device light propagating to the luminescent material may be controlled. Hence, also in this way the spectral power distribution, such as in specific embodiments CCT, may be controlled. Hence, in embodiments with the control system a plurality of first operational modes, wherein the system light may comprise luminescent material light and diffused second device light, may be realized.

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc. Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface.

The control system may also be configured to receive and execute instructions from a remote control. In embodiments, the control system may be controlled via an App on a device, such as a portable device, like a Smartphone or I-phone, a tablet, etc. The device is thus not necessarily coupled to the lighting system, but may be (temporarily) functionally coupled to the lighting system.

Hence, in embodiments the control system may (also) be configured to be controlled by an App on a remote device. In such embodiments the control system of the lighting system may be a slave control system or control in a slave mode. For instance, the lighting system may be identifiable with a code, especially a unique code for the respective lighting system. The control system of the lighting system may be configured to be controlled by an external control system which has access to the lighting system on the basis of knowledge (input by a user interface of with an optical sensor (e.g. QR code reader) of the (unique) code. The lighting system may also comprise means for communicating with other systems or devices, such as on the basis of Bluetooth, Thread, WIFI, LiFi, ZigBee, BLE or WiMAX, or another wireless technology.

The system, or apparatus, or device may execute an action in a “mode” or “operation mode” or “mode of operation” or “operational mode”. The term “operational mode may also be indicated as “controlling mode”. Likewise, in a method an action or stage, or step may be executed in a “mode” or “operation mode” or “mode of operation” or “operational mode”. This does not exclude that the system, or apparatus, or device may also be adapted for providing another controlling mode, or a plurality of other controlling modes. Likewise, this may not exclude that before executing the mode and/or after executing the mode one or more other modes may be executed.

However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, that can only operate in a single operation mode (i.e. “on”, without further tunability).

Hence, in embodiments, the control system may control in dependence of one or more of an input signal of a user interface, a sensor signal (of a sensor), and a timer. The term “timer” may refer to a clock and/or a predetermined time scheme. In specific embodiments, inputs for such a control system may be, next to target setting signals or boundary signals, sensor signals, such as temperature-correlated signals, optical flux correlated signals, and/or optical flux ratio or color point correlated signals, etc.

In specific embodiments, the system light may be white light. Hence, in embodiments, when controlling one or more of (i) the polarization control element, (ii) a radiant flux of the first device light, and (iii) a radiant flux of the second device light, the spectral power distribution of the (white) system light may be controlled. Therefore, in specific embodiments the correlated color temperature of the system light may be controlled. Yet, in further specific embodiments the control system is configured to control a correlated color temperature of the system light in dependence of one or more of a user interface, a sensor signal, and a timer.

The term “white light”, and similar terms, herein, is known to the person skilled in the art. It may especially relate to light having a correlated color temperature (CCT) between about 1800 K and 20000 K, such as between 2000 and 20000 K, especially 2700-20000 K, for general lighting especially in the range of about 2000-7000 K, such as in the range of 2700 K and 6500 K. In embodiments, e.g. for backlighting purposes, or for other purposes, the correlated color temperature (CCT) may especially be in the range of about 7000 K and 20000 K. Yet further, in embodiments the correlated color temperature (CCT) is especially within about 15 SDCM (standard deviation of color matching) from the BBL (black body locus), especially within about 10 SDCM from the BBL, even more especially within about 5 SDCM from the BBL.

In specific embodiments, the correlated color temperature (CCT) may be selected from the range of 6000-12000 K, like selected from the range of 7000-12000 K, like at least 8000 K. Yet further, in embodiments the correlated color temperature (CCT) may be selected from the range of 6000-12000 K, like selected from the range of 7000-12000 K, in combination with a CRI of at least 70.

In an embodiment, the light source may also provide light source light having a correlated color temperature (CCT) between about 5000 and 20000 K, e.g. direct phosphor converted LEDs (blue light emitting diode with thin layer of phosphor for e.g. obtaining of 10000 K). Hence, in a specific embodiment the light source is configured to provide light source light with a correlated color temperature in the range of 5000-20000 K, even more especially in the range of 6000-20000 K, such as 8000-20000 K. An advantage of the relative high color temperature may be that there may be a relatively high blue component in the light source light.

The terms “visible”, “visible light” or “visible emission” and similar terms refer to light having one or more wavelengths in the range of about 380-780 nm. Herein, UV may especially refer to a wavelength selected from the range of 190-380 nm, such as 200-380 nm.

In embodiments, the first dichroic beam splitter may be configured (a) to transmit or reflect at least 70%, more especially at least 80% of the first device light received by the first dichroic beam splitter, such as especially at least about 90%. Alternatively or additionally, the first dichroic beam splitter may be configured (b) to reflect or transmit at least (b1) 70%, more especially at least 80% of the luminescent material light received by the first dichroic beam splitter and at least 70%, more especially at least 80% of the second device light received by the first dichroic beam splitter, such as especially as at least 90% of the luminescent material light received by the first dichroic beam splitter and (b2) at least 70%, more especially at least 80%, such as at least 90% of the second device light received by the first dichroic beam splitter. For this reason, it may also be desirable that λ2>λ1 applies. Note that when the first dichroic beam splitter is configured to reflect at least part of the first device light, it may also be configured to transmit at least part of the luminescent material light and at least part of the second device light. Likewise, when the first dichroic beam splitter is configured to transmit at least part of the first device light, it may also be configured to reflect at least part of the luminescent material light and at least part of the second device light.

In embodiments, (i) the first dichroic beam splitter may be configured (a) to transmit at least 80% of the first device light received by the first dichroic beam splitter, and (b) to reflect at least 80% of the luminescent material light received by the first dichroic beam splitter and at least 80% of the second device light received by the first dichroic beam splitter, or (ii) the first dichroic beam splitter may be configured (a) to reflect at least 80% of the first device light received by the first dichroic beam splitter, and (b) to transmit at least 80% of the luminescent material light received by the first dichroic beam splitter and at least 80% of the second device light received by the first dichroic beam splitter.

Further, in embodiments, the central optics dichroic beam splitter may be configured (a) to transmit or reflect at least 70% of the second device light received by the central optics dichroic beam splitter, more especially at least 80%, such as at least 90%. Alternatively or additionally, the central optics dichroic beam splitter may be configured (b) to reflect or transmit at least 70% of the luminescent material light received by the central optics dichroic beam splitter, more especially at least 80%, such as at least 90%. Note that when the central optics dichroic beam splitter is configured to reflect at least part of the second device light, it may also be configured to transmit at least part of the luminescent material light. Likewise, when the central optics dichroic beam splitter is configured to transmit at least part of the second device light, it may also be configured to reflect at least part of the luminescent material light.

In embodiments, the central optics dichroic beam splitter may be configured (a) to transmit at least 80% of the (p-polarized) second device light received by the central optics dichroic beam splitter, and to reflect at least 80% of the luminescent material light received by the central optics dichroic beam splitter, or (b) to reflect at least 80% of the (s-polarized) second device light received by the central optics dichroic beam splitter, and to transmit at least 80% of the luminescent material light received by the central optics dichroic beam splitter.

In embodiments, the central optics dichroic beam splitter may comprise a polarizing beam splitting (PBS) coating (without any spectral requirement in the luminescent spectral range (i.e., it may be either (i) transmissive or (ii) reflective or (iii) partly transmissive and partly reflective for luminescent material light)) and an dichroic beam splitting coating (DBS). This configuration may especially be suitable if the central optics is reflective for the luminescent material light. In another embodiment, both functions (i.e. the PBS and DBS functions) may be combined in a single layer. This configuration may be suitable for both configurations i.e. if the central optics is reflective for the luminescent material light or if the central optics is transmissive for the luminescent material.

The polarizing beam splitter comprised by the central optics may be configured to transmit part of the s-polarized light and reflect part of the s-polarized light. Likewise, it may be configured to reflect at least part of the p-polarized light and transmit at least part of the p-polarized light. The percentage of transmission and reflection for the respective polarization may be defined by the polarizing beam splitter. An example of such partially polarizing beam splitter is e.g. a broadband partially polarizing beam splitter that at 450 nm transmits about 77% of p-polarized light and substantially no s-polarized light, while it reflects ca. 10% of p-polarized light and 86% of s-polarized light.

Especially, the optics polarizing beam splitter is configured such that for one polarization the transmittance is not complete, and thus may be partly reflected, whereas for the other polarization, the reflectance may be relatively high, and thus may have a small transmission or essentially no transmission. However, this may also be the other way around. In specific embodiments, the central optics polarizing beam splitter may be configured to transmit x % of light having p polarization and reflect y % of light having s polarization, wherein one of x % and y % is selected from the range of 15-80%, and the other one of x % and y % is selected from the range of 85-100%.

Hence, in embodiments the central optics polarizing beam splitter may be configured to transmit a larger part of the p-polarized light than a part of the s-polarized that is reflected. In other embodiments, the central optics polarizing beam splitter may be configured to transmit a larger part of the s-polarized light than a part of the p-polarized that is reflected. In yet other embodiments, the central optics polarizing beam splitter may be configured to reflect a larger part of the s-polarized light than a part of the p-polarized that is transmitted. In yet other embodiments, the central optics polarizing beam splitter may be configured to reflect a larger part of the p-polarized light than a part of the s-polarized that is transmitted.

Hence, the central optics polarizing beam splitter may especially be a partially polarizing beam splitter.

In order to further increase input power and/or to provide a further control options, more than one type of first light generating device may be applied, wherein at least two types differ in the polarized light they provide. For instance, in embodiments one of the types may e.g. have primarily s-polarized light, and another one of the types may e.g. have primarily p-polarized light. A polarizing beam splitter may be used to combine the beams of the two types of first light generating devices. Hence, the term first light generating device may also refer to one or more primary first light generating device and one or more secondary first light generating devices. Therefore, in embodiments the system may comprise a primary first light generating device and a secondary first light generating device, wherein the device light of one of the primary first light generating device and the secondary first light generating device, comprises more s-polarized than the other one of the primary first light generating device and the secondary first light generating device, wherein the light generating system further comprises second optics, configured downstream of the primary first light generating device and the secondary first light generating device, and configured upstream of the first optics, wherein the second optics comprises a first polarizing beam splitter, wherein the first polarizing beam splitter is configured to transmit s-polarized light or p-polarized light, and to reflect p-polarized light or s-polarized light. For instance, in embodiments the device light of the other one of the primary first light generating device and the secondary first light generating device, comprises more p-polarized than the one of the primary first light generating device and the secondary first light generating device. For example, the light generating system may comprise a primary first light generating device and a secondary first light generating device, wherein the device light of one of the primary first light generating device and the secondary first light generating device, may comprise more s-polarized (light) than the other one of the primary first light generating device and the secondary first light generating device, wherein the light generating system may further comprises second optics, configured downstream of the primary first light generating device and the secondary first light generating device, and configured upstream of the first optics, wherein the second optics may comprise a first polarizing beam splitter, wherein the first polarizing beam splitter may be configured to reflect s-polarized light and to transmit p-polarized light. Especially, the device light of the other one of the primary first light generating device and the secondary first light generating device, may comprises more p-polarized (light) than the one of the primary first light generating device and the secondary first light generating device. In a preferred embodiment, (i) at least 80% (or at least 90% such as 100%) of the device light of the primary first light generating device may be s-polarized light, and at least 80% (or at least 90% such as 100%) of the device light of the secondary first light generating device may be p-polarized light; or (ii) at least 80% (or at least 90% such as 100%) of the device light of the primary first light generating device may be p-polarized light, and at least 80% (or at least 90% such as 100%) of the device light of the secondary first light generating device may be s-polarized light.

One or more primary first light generating devices, especially a plurality of primary first light generating device, may be configured in a laser bank, wherein the primary first light generating devices comprise laser diodes. Alternatively or additionally, one or more secondary first light generating devices, especially a plurality of secondary first light generating device may be configured in a laser bank, wherein the secondary first light generating devices comprise laser diodes. The laser banks may be different laser banks, though a configuration in the same laser bank may also be possible.

Alternatively or additionally, in order to further increase input power and/or to provide a further control options, more than one type of first light generating device may be applied, wherein at least two types differ in the spectral power distribution they provide. One of the types may have a different wavelength than the other one, such as a different peak wavelengths, and a dichroic beam splitter may be used to combine the beams of the two types of first light generating devices. When using a (simple) cut-on or cut-off dichroic pass filter, in combination with a PBS e.g. up to four light source beams may be combined within the same etendue (i.e., may be projected within the same spot and angular range on the phosphor). Especially, for the type of first light generating devices having device light with the largest peak wavelength this largest peak wavelength is the first peak wavelength as described herein. Any further type of first light generating device may generate first device light have the same peak wavelength or a peak wavelength at smaller wavelengths. Further, for all types of first light generating devices may the conditions apply as described herein in relation to the first light generating device.

Alternatively or additionally, in order to further increase input power and/or to provide a further control options, more than one type of second light generating device may be applied, wherein at least two types differ in the spectral power distribution they provide. One of the types may have a different wavelength than the other one, such as a different peak wavelengths, and a dichroic beam splitter may be used to combine the beams of the two types of second light generating devices. When using a (simple) cut-on or cut-off dichroic pass filter, in combination with a PBS e.g. up to four light source beams may be combined within the same etendue (i.e., may be projected within the same spot and angular range on the phosphor). Especially, for the type of second light generating devices having device light with the smallest peak wavelength this smallest peak wavelength is the second peak wavelength as described herein. Any further type of second light generating device may generate second device light have the same peak wavelength or a peak wavelength at larger wavelengths. Further, for all types of second light generating devices may the conditions apply as described herein in relation to the second light generating device.

The terms “upstream” and “downstream” relate to an arrangement of items or features relative to the propagation of the light from a light generating means (here the especially the light source), wherein relative to a first position within a beam of light from the light generating means, a second position in the beam of light closer to the light generating means is “upstream”, and a third position within the beam of light further away from the light generating means is “downstream”.

In embodiments, laser banks may (thus) be applied. Laser banks may also be used to boast the input power. Therefore, in embodiments the system may comprise a plurality of first light generating devices configured in a first laser bank, wherein the first light generating devices are configured to generate the first device light, wherein the first device light is laser light, and/or a plurality of second light generating devices configured in a second laser bank, wherein the second light generating devices are configured to generate the second device light, wherein the second device light is laser light. The laser banks may be different laser banks, though a configuration (of different types of light generating devices) in the same laser bank may also be possible.

With high power irradiation of the luminescent material, the thermal load may become critical. Hence, in embodiments the luminescent material may be configured to extend in a circular configuration, such as on a disc, and may be rotated during operation of the system. In this way, the luminescent material is only temporarily heated, and is allowed to cool during a (short) time before it is again irradiated. Hence, in embodiments the system may comprise a rotatable element, wherein the rotatable element comprises the luminescent material; wherein during operation of the light generating system (in the first operational mode) the rotatable element rotates, such that over time different parts of the luminescent material are irradiated by the first device light and/or second device light. Likewise, this may apply to the diffuser element. Hence, in embodiments the system may comprise a rotatable element, wherein the rotatable element comprises the diffuser element; wherein during operation of the light generating system (in the first operational mode) the rotatable element rotates, such that over time different parts of the diffuser element are irradiated by the second device light. Rotational frequencies may e.g. be selected from the range of 40-300 Hz, though other rotational frequencies may also be possible. Hence, typically, the duration of irradiating the luminescent material is much shorter (≥10x, more commonly ≥50x) than the duration of not irradiating the luminescent material. In embodiments, the rotatable element may be provided as wheel or disc. Hence, in embodiments the rotatable element may comprise a phosphor wheel. However, rotating rods may also be applied.

Especially, the embodiments with the rotatable element may be combined. Hence, the system may comprise a rotatable element, wherein the rotatable element comprises the luminescent material; wherein during operation of the light generating system (in the first operational mode) the rotatable element rotates, such that over time different parts of the luminescent material are irradiated by the first device light and/or second device light, wherein the rotatable element also comprises the diffuser element, spatially separated from the luminescent material; wherein during operation of the light generating system (in the first operational mode) the rotatable element rotates, such that over time different parts of the diffuser element are irradiated by the second device light.

Hence, the system may further comprise an actuator configured to rotate the rotatable element. The control system may control the actuator (and thereby the rotational frequency).

Further, in embodiments the luminescent material may be configured in thermal contact with a thermally conductive material. For instance, the luminescent material may be configured in thermal contact with a thermally conductive element.

A thermally conductive element may especially comprise thermally conductive material. A thermally conductive material may especially have a thermal conductivity of at least about 20 W/(m*K), like at least about 30 W/(m*K), such as at least about 100 W/(m*K), like especially at least about 200 W/(m*K). In yet further specific embodiments, a thermally conductive material may especially have a thermal conductivity of at least about 10 W/(m*K). In embodiments, the thermally conductive material may comprise one or more of copper, aluminum, silver, gold, silicon carbide, aluminum nitride, boron nitride, aluminum silicon carbide, beryllium oxide, a silicon carbide composite, aluminum silicon carbide, a copper tungsten alloy, a copper molybdenum carbide, carbon, diamond, and graphite. Alternatively, or additionally, the thermally conductive material may comprise or consist of aluminum oxide. In embodiments, the thermally conductive element may comprise one or more of a heatsink, a heat spreader, and a two-phase cooling device. In yet other embodiments, the thermally conductive element may be configured in thermal contact with one or more of a heatsink, a heat spreader, and a two-phase cooling device, and may e.g. transfer heat to such heatsink, heat spreader, or two-phase cooling device, via another thermally conductive element.

An element may be considered in “thermal contact” with another element if it can exchange energy through the process of heat. Hence, the elements may be thermally coupled. In embodiments, thermal contact can be achieved by physical contact. In embodiments, thermal contact may be achieved via a thermally conductive material, such as a thermally conductive glue (or thermally conductive adhesive). Thermal contact may also be achieved between two elements when the two elements are arranged relative to each other at a distance of equal to or less than about 10 μm, though larger distances, such as up to 100 μm may be possible. The shorter the distance, the better the thermal contact. Especially, the distance is 10 μm or less, such as 5 μm or less, such as 1 μm or less. The distance may be the distanced between two respective surfaces of the respective elements. The distance may be an average distance. For instance, the two elements may be in physical contact at one or more, such as a plurality of positions, but at one or more, especially a plurality of other positions, the elements are not in physical contact. For instance, this may be the case when one or both elements have a rough surface. Hence, in embodiments in average the distance between the two elements may be 10 μm or less (though larger average distances may be possible, such as up to 100 μm). In embodiments, the two surfaces of the two elements may be kept at a distance with one or more distance holders. When two elements are in thermal contact, they may be in physical contact or may be configured at a short distance of each other, like at maximum 10 μm, such as at maximum 1 mm. When the two elements are configured at a distance from each other, an intermediate material may be configured in between, though in other embodiments, the distance between the two elements may filled with a gas, liquid, or may be vacuum. When an intermediate material is available, the larger the distance, the higher the thermal conductivity may be useful for thermal contact between the two elements. However, the smaller the distance, the lower the thermal conductivity of the intermediate material may be (of course, higher thermal conductive materials may also be used).

Further, the system may in embodiments comprise further optics then described above. The term “optics” may especially refer to (one or more) optical elements. Hence, the terms “optics” and “optical elements” and “optical component” may refer to the same items. The optics may include one or more or mirrors, reflectors, collimators, lenses, prisms, diffusers, phase plates, polarizers, diffractive elements, gratings, dichroics, arrays of one or more of the afore-mentioned, etc. Alternatively or additionally, the term “optics” may refer to a holographic element or a mixing rod. In embodiments, the optics may include one or more of beam expander optics and zoom lens optics. See further above for examples of optics. In embodiments, the optics may comprise an integrator, like a “Koehler integrator” (or “Köhler integrator”). In specific embodiments, the system may further comprise one or more of integrating optics, collimation optics, and homogenization optics. One or more of them are also depicted in the accompanying drawings.

The light generating system may be part of or may be applied in e.g. office lighting systems, household application systems, shop lighting systems, home lighting systems, accent lighting systems, spot lighting systems, theater lighting systems, fiber-optics application systems, projection systems, self-lit display systems, pixelated display systems, segmented display systems, warning sign systems, medical lighting application systems, indicator sign systems, decorative lighting systems, portable systems, automotive applications, (outdoor) road lighting systems, urban lighting systems, green house lighting systems, horticulture lighting, digital projection, or LCD backlighting. The light generating system (or luminaire) may be part of or may be applied in e.g. optical communication systems or disinfection systems.

In yet a further aspect, the invention also provides a lamp or a luminaire comprising the light generating system as defined herein. The luminaire may further comprise a housing, optical elements, louvres, etc. etc . . . The lamp or luminaire may further comprise a housing enclosing the light generating system. The lamp or luminaire may comprise a light window in the housing or a housing opening, through which the system light may escape from the housing. In yet a further aspect, the invention also provides a projection device comprising the light generating system as defined herein. Especially, a projection device or “projector” or “image projector” may be an optical device that projects an image (or moving images) onto a surface, such as e.g. a projection screen. The projection device may include one or more light generating systems such as described herein. Hence, in an aspect the invention also provides a lighting device selected from the group of a lamp, a luminaire, a projector device, a disinfection device, a photochemical reactor, and an optical wireless communication device, comprising the light generating system as defined herein. The lighting device may comprise a housing or a carrier, configured to house or support, one or more elements of the light generating system. For instance, in embodiments the lighting device may comprise a housing or a carrier, configured to house or support one or more of the first light generating device, second light generating device, and one or more of the afore-mentioned optics. The lighting device may also be an automotive lighting device, such as a headlamp (or headlight) of a motorized vehicle (like a car, a truck, a bus, a coach, a tractor, a boat, an airplane, etc.).

The terms “light” and “radiation” are herein interchangeably used, unless clear from the context that the term “light” only refers to visible light. The terms “light” and “radiation” may thus refer to UV radiation, visible light, and IR radiation. In specific embodiments, especially for lighting applications, the terms “light” and “radiation” refer to visible light.

The term “centroid wavelength”, also indicated as λc, is known in the art, and refers to the wavelength value where half of the light energy is at shorter and half the energy is at longer wavelengths; the value is stated in nanometers (nm). It is the wavelength that divides the integral of a spectral power distribution into two equal parts as expressed by the formula λc=Σλ*I(λ)/(ΣI(λ)), where the summation is over the wavelength range of interest, and I(λ) is the spectral energy density (i.e. the integration of the product of the wavelength and the intensity over the emission band normalized to the integrated intensity). The centroid wavelength may e.g. be determined at operation conditions.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1-6 schematically depict some embodiments;

FIG. 7 schematically depict some application embodiments; and

FIG. 8 schematically depicts some further aspects.

The schematic drawings are not necessarily to scale.

### DETAILED DESCRIPTION OF THE EMBODIMENTS

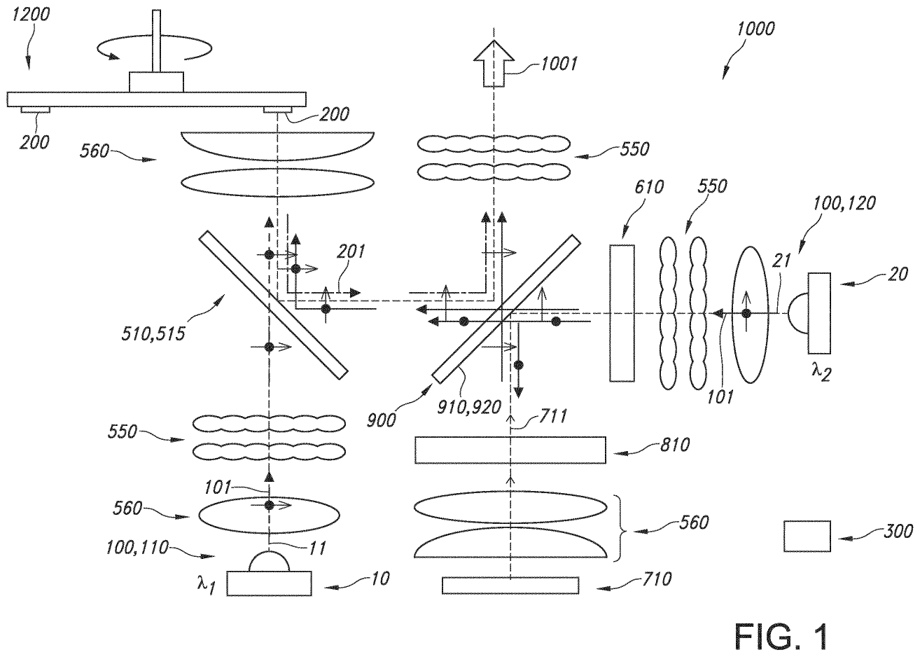

FIGS. 1-6 schematically depict embodiments of a light generating system 1000 comprising a first light generating device 110, a second light generating device 120, a luminescent material 200, first optics 510, a polarization control element 610, a diffuser element 710, a polarization changing element 810, and central optics 900. Here below, the schematical drawings 1-6 are described in general, with some attention to specific drawings.

Light generating devices are herein indicated with the general reference 100. Light generating devices are configured to generate device light 101. Hence, the first light generating device 110 and the second light generating device 120 are embodiments of a light generating device 100. Likewise, first device light 111 and second device light 121 are examples of device light 101. The first light generating device 110 may also refer to a plurality of first light generating devices 110 in a laser bank. Likewise, the second light generating device 120 may also refer to a plurality of second light generating devices 120 in a laser bank.

Especially, the first light generating device 110 may be configured to generate first device light 111. Further, in embodiments the first device light 111 may comprise one or more of polarized light having a p polarization and polarized light having an s polarization; the first device light 111 may also be unpolarized light. In embodiments, the first light generating device 110 may comprise a first light source 10 selected from a laser diode and a superluminescent diode. The first light source 10 may generate first light source light 11. Especially, the first device light 111 has a first peak wavelength λ1. The first device light 111 may in embodiments essentially consist of first light source light 11.

Especially, the second light generating device 210 may be configured to generate second device light 121. Further, in embodiments the second device light 121 may comprise one or more of polarized light having a p polarization and polarized light having an s polarization. In embodiments, the second light generating device 120 may comprise a second light source 20 selected from a laser diode and a superluminescent diode. The second light source 20 may generate second light source light 21. Especially, the second device light 121 has a second peak wavelength λ2. The second device light 121 may in embodiments essentially consist of second light source light 21. Further, in embodiments |λ1−λ2|≥5 nm, more especially at least 10 nm. Further, especially λ2>λ1.

In embodiments, the luminescent material 200 may be configured to convert first device light 111 and/or second device light 121 received by the luminescent material 200 into luminescent material light 201. The luminescent material 200 may in embodiments at least comprise a luminescent material of the type A₃B₅O₁₂:Ce, wherein A may comprise one or more of Y, La, Gd, Tb and Lu, and wherein B may comprise one or more of Al, Ga, In and Sc. Alternatively or additionally, other luminescent material may be applied (see elsewhere herein).

Further, in embodiments the first optics 510 may comprise a first dichroic beam splitter 515 (and may be configured downstream of the first light generating device 110 and upstream of the luminescent material 200). The first dichroic beam splitter 515 may in embodiments be configured (a) to transmit or reflect at least part of the first device light 111, and (b) to reflect or transmit at least part of the luminescent material light 201.

Hence, in embodiments, the first dichroic beam splitter 515 may be configured (a) to transmit at least part of the first device light 111, and (b) to reflect at least part of the luminescent material light 201, and may in other embodiments be configured (a) to reflect at least part of the first device light 111, and (b) to transmit at least part of the luminescent material light 201.

In embodiments, the polarization control element 610 may be configured to control a degree of polarization of the polarized light. Especially, the degree of polarization may be defined as a percentage of the p-polarized light or the s-polarized light relative to the total of s-polarized light and p-polarized light. The percentages may in embodiments be based on the angular luminances of the device light with the respective polarizations.

Hence, the second device light downstream of the polarization control element may have a polarization selected from: essentially p-polarized, essentially s-polarized, and a combination of p-polarized and s-polarized. This polarization may in embodiments be controlled by rotating the polarization control element. Hence, when the polarization control element is controllable, it may have at least two polarizations e.g. selected from: essentially p-polarized, essentially s-polarized, and a combination of p-polarized and s-polarized.

Further, in embodiments the diffuser element 710 may be configured to diffuse (by reflection) at least part of the first device light 111 and/or second device light 121 received by the diffuser element 710 thereby providing diffused second device light 711 while maintaining at least part of the polarization of the second device light.

In embodiments, the diffuser element 710 may e.g. be a N-BK7 Diffuse Reflector, Protected Silver Coating (thorlabs.com), which is a metallic coated glass diffuser showing 95-98% reflectance (depending on polarization details). Especially, metallic coated (or metallic) reflective surface diffusers (or probably also reflective dielectric stack coated surface-texture diffusers) may show a relatively good polarization maintenance, see also e.g. U.S. Pat. No. 8,072,681B2 (Polarization preserving front projection screen material), which is herein also incorporated by reference.

In specific embodiments, the polarization changing element 810 may comprise a λ/4 waveplate. Especially, the polarization changing element 810 may be configured in an optical path of the second device light 121 between the central optics 900 and the diffuser element 710.

Starting with linear s-polarized light, it is converted by the λ/4 element into e.g. right-handed circular pol. Light, which is converted by the polarization maintaining reflective diffuser into left-handed circular polarized light, which now is converted by the λ/4 element into linear p-polarized light. Likewise, p-polarized light may be converted into diffused s-polarized light. Hence, second device light may pass the polarization changing element twice, one time propagating from the central optics to the diffuser element, and having a first polarization, and one time propagating from the diffuser element to the central optics, being diffused at the diffuser element and obtaining a second polarization when passing the polarization changing element (in the direction of the central optics).

In embodiments, the central optics 900 may comprise (i) a central optics polarizing beam splitter 910, and (ii) a central optics dichroic beam splitter 920. In specific embodiments, the central optics polarizing beam splitter 910 may be configured to transmit and/or reflect at least part of the second device light 121 in dependence of its polarization. Note this central optics polarizing beam splitter 910 may be a partial polarizing beam splitter. Further, in specific embodiments the central optics dichroic beam splitter 920 may be configured to (a) to transmit or reflect at least part of the second device light 121, and (b) to reflect or transmit at least part of the luminescent material light 201. Hence, in embodiments the central optics dichroic beam splitter 920 may be configured to (a) to transmit at least part of the second device light 121, and (b) to reflect at least part of the luminescent material light 201, and in other embodiments the central optics dichroic beam splitter 920 may be configured to (a) to reflect at least part of the second device light 121, and (b) to transmit at least part of the luminescent material light 201.

An example of a broadband fully polarizing beam splitter that transmits p-polarized light above 420 nm (Tp>98%) and reflects all s-polarized light (Ts<0.1%) is Thorlabs PBS251. An example of a broadband partially polarizing beam splitter that at 450 nm transmits ca 77% of p-polarized light and substantially no s-polarized light while it reflects ca 10% of p-polarized light and 86% of s-polarized light is Thorlabs WPBS254-VIS.

An example of p-polarized transmission Tp between 10% and 100% while the s-polarized light is all reflected, where the ratio is a function of the wavelength (in this case between 370 and 410 nm) is Thorlabs PBS25-355-HP. This principle may also apply to other wavelengths as well, i.e., the splitter can be designed to achieve a certain transmission at a certain wavelength for p- and/or s-polarized light. A further example of Ts=40% and Tp=70% at 450 nm (with Rs=60% and Rp=30%) is Thorlabs PBSW-405. Here, Ts indicates the transmission of s-polarized light, Tp refers to transmission of p-polarized light, Rs indicates the reflection of s-polarized light, Rp refers to reflection of p-polarized light.

The central optics 900 may thus comprise at least two functionalities. It may be implemented as two optical components each providing one of the functions, as two functional surfaces of a single component, or as stacked functional layers on a single surface of a single component, where all previous options have the two functions still in separate functional layers, or integrated in one layer, where each functional “functional layer” is to be understood as a structured layer (such as a metal wire grid) or as a stack of one or more (dielectric) sub-layers.

Yet, especially the light generating system 1000 may be configured to provide system light 1001 comprising one or more of diffused second device light 711 and luminescent material light 201. Further, especially the light generating system 1000 may be configured such that in a first operational mode of the light generating system 1000 (a) at least part of the first device light 111 irradiates the luminescent material 200 via the first optics 510, and the (thus generated) luminescent material light 201 escapes from the light generating system 1000 via the first optics 510 and the central optics 900, and (b) at least part of the second device light 121 irradiates the diffuser element 710 via the central optics 900, and at least part of the (thus generated) diffused second device light 711 escapes from the light generating system 1000 via the central optics 900.

A position where system light 1001 escapes from the light generating system 1000 may also be indicated as light exit (not depicted). This may be a light transmissive window or an opening (in the system). The light transmissive window may in embodiments be provided by an optical component. Especially, reference 1001 refers to system light 1001 escaped from the system 1000.

In specific embodiments, the first device light 111 and the second device light have a wavelength selected from the blue wavelength range. Especially, the first device light 111 and the second device light have a peak wavelength selected from the blue wavelength range. Further, in embodiments the luminescent material light 201 may have a wavelength selected from the green-red wavelength range, such as selected from the green and/or yellow. Especially, the luminescent material light 201 may have a centroid wavelength selected from the green-red wavelength range. For instance, the luminescent material light may be yellow light. Also a combination of green and red may be possible, for instance when two (or more) different luminescent materials are applied. In specific embodiments, the luminescent material 200 may comprise at least two different luminescent materials 200 configured to provide luminescent material light 201 having different spectral power distributions. In specific embodiments, the system light 1001 in the first operational mode may be white light.

In specific embodiments, the polarization control element 610 may comprise a rotatable birefringent rotator. Especially, the (rotatable) birefringent rotator may comprise a λ/2 waveplate.

Yet, in specific embodiments the light generating system 1000 may further comprise a control system 300. In embodiments, the control system 300 may be configured to control a spectral power distribution of the system light 1001 by controlling one or more of (i) the polarization control element 610, (ii) a radiant flux of the first device light 111, and (iii) a radiant flux of the second device light 121. In embodiments, the control system 300 may be configured to control a correlated color temperature of the system light 1001, for instance in dependence of one or more of a user interface, a sensor signal, and a timer. For controlling the polarization control element, an actuator (not depicted) may be applied.

In embodiments, the first dichroic beam splitter 515 may be configured (a) to transmit or reflect at least 80%, such as at least 90% of the first device light 111 received by the first dichroic beam splitter 515, and (b) to reflect or transmit at least 80%, such as at least 90% of the luminescent material light 201 received by the first dichroic beam splitter 515 and at least 80%, such as at least 90% of the second device light 121 received by the first dichroic beam splitter 515. Yet, in specific embodiments, the central optics dichroic beam splitter 920 may be configured (a) to transmit or reflect at least 80%, such as at least 90% of the second device light 121 received by the central optics dichroic beam splitter 920, and (b) to reflect or transmit at least 80%, such as at least 90% of the luminescent material light 201 received by the central optics dichroic beam splitter 920.

In specific embodiments, the central optics polarizing beam splitter 910 may be configured to transmit x % of light having p polarization and reflect y % of light having s polarization. In further specific embodiments, one of x % and y % may be selected from the range of 15-80%, and the other one of x % and y % may be selected from the range of 85-100%.

Further, in specific embodiments the light generating system 1000 may comprise a primary first light generating device 110 and a secondary first light generating device 110. Especially, the device light 111 of one of the primary first light generating device 110 and the secondary first light generating device 110, may comprise more s-polarized than the other one of the primary first light generating device 110 and the secondary first light generating device 110. Yet, in embodiments the light generating system 1000 may further comprise second optics 520, configured downstream of the primary first light generating device 110 and the secondary first light generating device 110, and configured upstream of the first optics 510. In embodiments, the second optics 520 may comprise a first polarizing beam splitter 525. Especially, the first polarizing beam splitter 525 may be configured to transmit s-polarized light or p-polarized light, and to reflect p-polarized light or s-polarized light. Hence, in embodiments, the first polarizing beam splitter 525 may be configured to transmit s-polarized light, and to reflect p-polarized light, and in other embodiments, the first polarizing beam splitter 525 may be configured to transmit p-polarized light, and to reflect s-polarized light.

In specific embodiments, the light generating system 1000 may comprise a plurality of first light generating devices 110 configured in a first laser bank. Especially, the first light generating devices 110 are configured to generate the first device light 111. In specific embodiments, the light generating system 1000 may comprise a plurality of second light generating devices 120 configured in a second laser bank. Especially, the second light generating devices 120 are configured to generate the second device light 121.

Especially, in embodiments the first device light 111 may be laser light. Especially, the second device light 121 may (also) be laser light.

In specific embodiments, the light generating system 1000 may comprising a rotatable element 1200. In further specific embodiments, the rotatable element 1200 may comprise the luminescent material 200. During operation of the light generating system 1000 the rotatable element 1200 may rotate, such that over time different parts of the luminescent material 200 are irradiated by the first device light 111 and/or second device light 121.

In further specific embodiments, the rotatable element 1200 may also comprise the diffuser element 710, spatially separated from the luminescent material 200. During operation of the light generating system 1000 the rotatable element 1200 may rotate, such that over time different parts of the diffuser element 710 are irradiated by the second device light 121.

For controlling the rotatable element 1200, an actuator (not depicted) may be applied.

In embodiments, the luminescent material 200 may be configured in thermal contact with a thermally conductive element. For instance, the luminescent material 200 may be configured in thermal contact with a thermally conductive material.

Further, in specific embodiments the light generating system 1000 may in addition comprise one or more of integrating optics, collimation optics, and homogenization optics. For instance, reference 560 refers to lenses, especially used for collimation of light. Reference 550 refers to integrators, which may especially be used to beam shape and homogenize light. However, further optics than schematically depicted may be available.

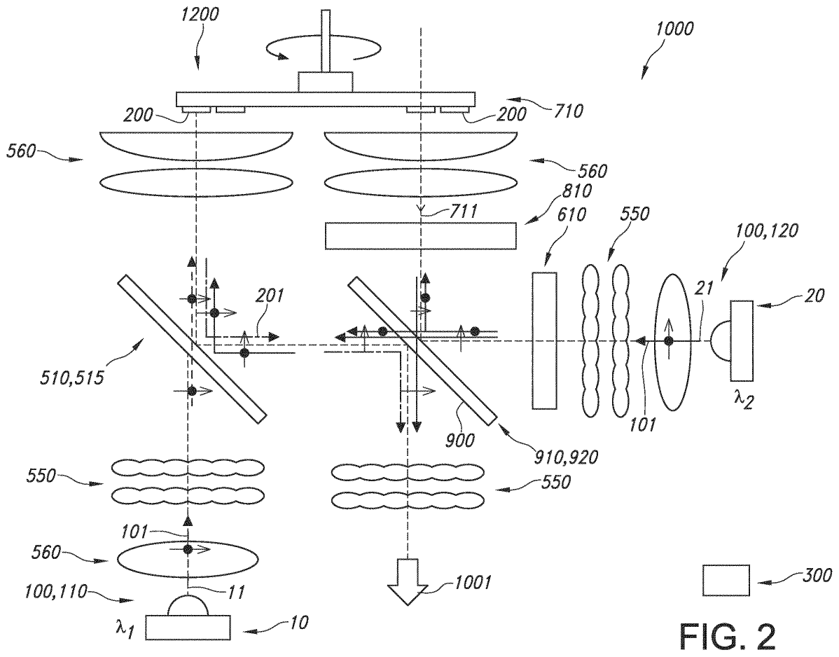

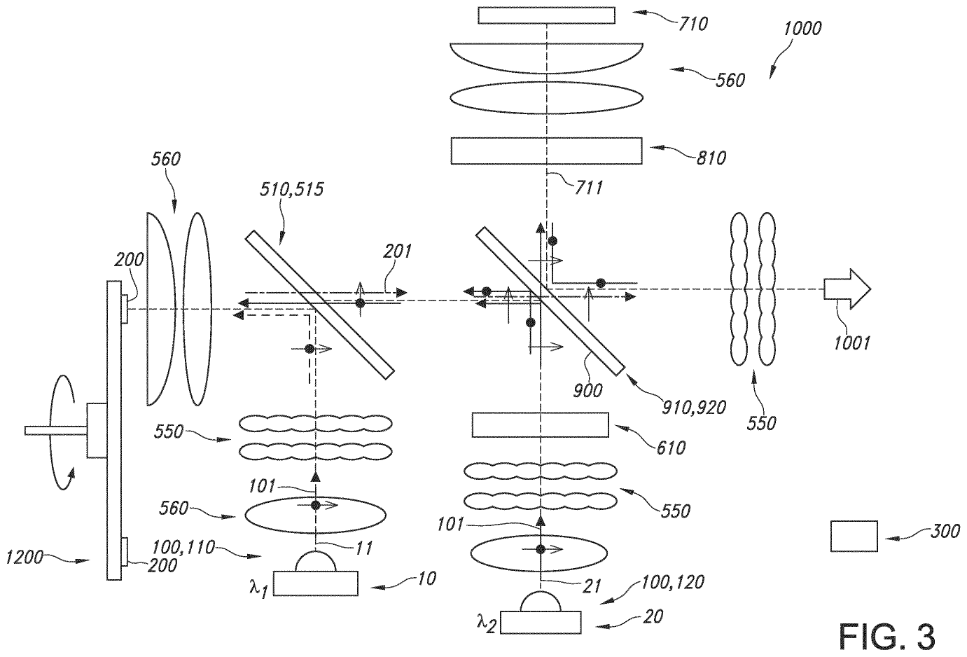

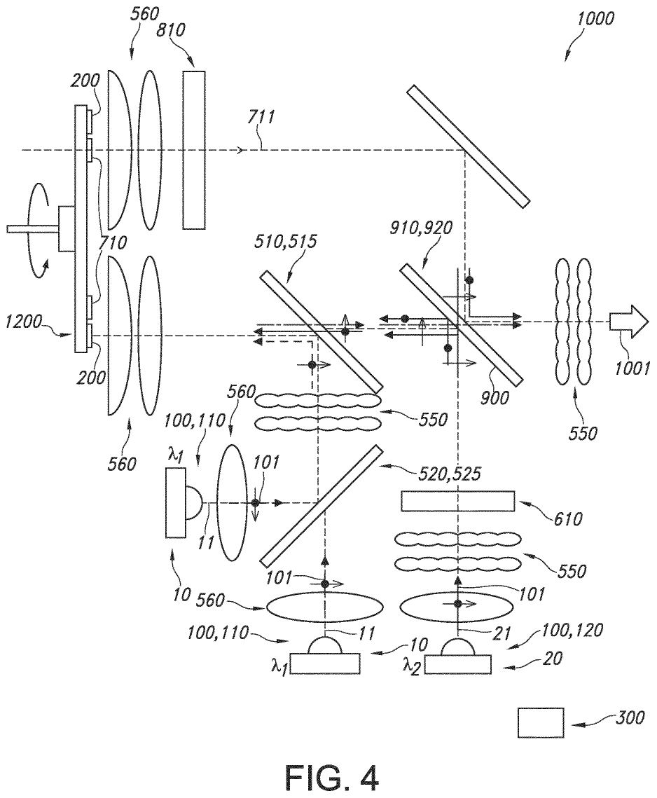

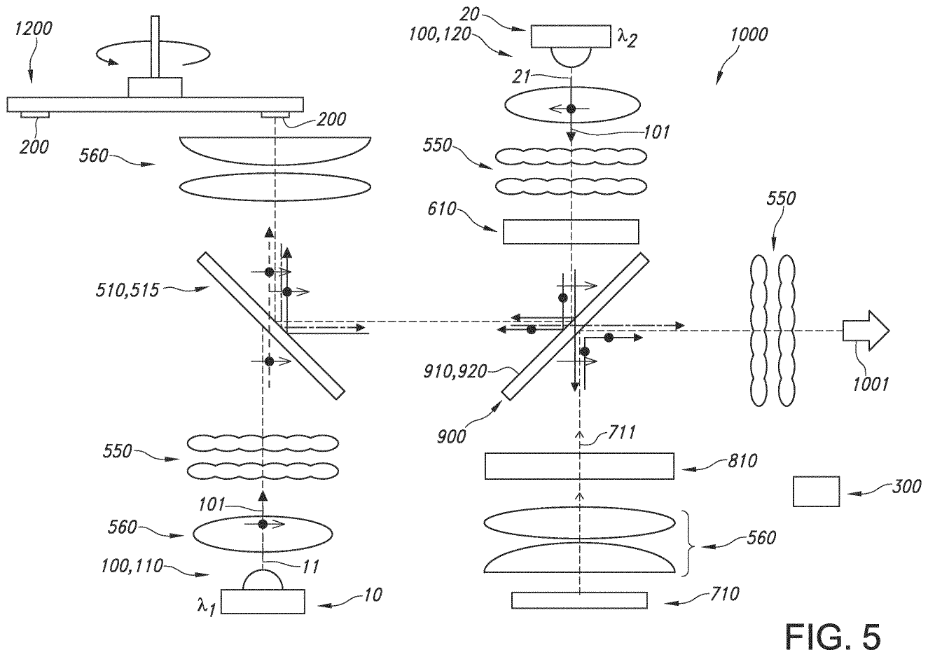

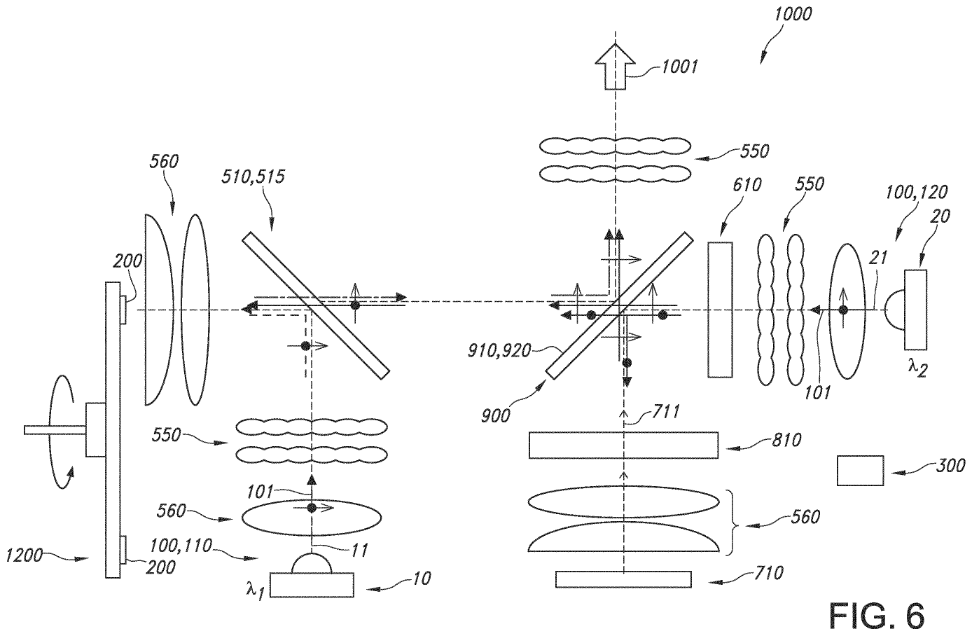

Referring to the schematically depicted dichroic beam splitters, e.g. for the configuration of FIG. 1, FIG. 2, and FIG. 5, a short-pass (450 nm cut-off) dichroic plate, e.g. designed for 45° angle of incidence such as Edmund Optics #69-213, see Dichroic Shortpass Filters|Edmund Optics. For instance for the config of FIG. 3, FIG. 4, and FIG. 6, a long-pass (458 nm cut-in) dichroic plate designed for 45° incidence such as Edmund Optics #67-078, see 458 nm, 25.2×35.6 mm, Dichroic Filter|Edmund Optics, or 466 nm cut-on such as Edmund Optics #86-383, see Dichroic Laser Beam Combiners|Edmund Optics.

The characteristics of the polarizing beam splitter (PBS) in FIG. 1, FIG. 2, and FIG. 6 may essentially be the same. For FIG. 3 it may be different, as here not a reflected but a transmitted portion of the second device light is used for diffusion, so here at max a partial transmission may be requested. Note with e.g. FIG. 1 and FIG. 2: it may be possible to use here a fully polarizing beam splitter, as that enables any ratio of power split to the phosphor and to the diffuser. However, it is desirable that at least a certain fraction of blue power is sent to the diffuser to obtain white light. If that fraction is e.g. 50% of the second device, we only need e.g. Rs=50% with Tp=100%, with the advantage that any depolarization by the diffuser is still for 50% transmitted to the output rather than totally lost.

Note with FIG. 3: this may work with Tp=100%, but when e.g. only 50% split off to the diffuser may be needed, then Tp=50% may be sufficient with Ts=0% and again this means that blue losses due to depolarization by the diffuser are reduced by 50%. For smaller requested diffused blue contributions, the reduction of depolarization losses can be further reduced. So, if e.g. 20-40% of the power is needed for splitting off to the diffuser for the tunable color point, with Ts=low, Tp may be in the range of 40-100% (and preferably 40%). As not for all applications the higher blue content may be requested, a lower limit may be set at 20%. So, it may be in the range 20-100%, e.g. 30-70%. Still values of <20% are not necessarily excluded.

Referring to FIG. 4, this schematically depicted embodiment may lead to somewhat different preferred PBS central characteristics, as now there are two laser (banks) used for directly pumping the phosphor and one for splitting off part to the diffuser, and therefore a larger percentage of the longer wavelength blue may be needed for diffusion. As the sources may typically have comparable output power, this may mean that a fraction that is 1.5× more than in the other cases may be split off towards the diffuser. So if the other cases are assigned a preferred Tp of Ts (depending on the configuration) range of 30-70%, then for the FIG. 4 embodiment this could be about 45-100% (Tp). Of course there is also the alternative for FIG. 2 using the “inverse” central PBS, i.e., reflective for luminescent light, and then here a Ts of 45-100% may be desirable.

Referring to FIGS. 1-6, especially the first optics may be configured in an optical path of the first device light between the first light generating device and the luminescent material. Likewise, the first optics may be configured in an optical path of the luminescent material light between the luminescent material and the central optics. The central optics may be configured in an optical path of the luminescent material light between the first optics and a light exit of the system. Further, the central optics may be configured in a central path of the diffused light between the diffuser element and a light exit of the system. Further, the central optics may be configured in an optical path of the second device light between the second light generating device and the diffuser element. Further, the first optics may be configured in an optical path of the second device light between the central optics and the luminescent material. Further, the polarization changing element may be configured in an optical path of the second device light between the central optics and the diffuser element.

Laser diode (LD) banks are typically being offered with a center wavelength (WL) of 455 nm or 465 nm. Although the longer wavelength blue LD's show a somewhat lower external quantum efficiency (EQE), or wall plug efficiency (WPE), and optical output power (Pₒₚₜ), the luminous equivalence (LE) is significantly higher thanks to the larger overlap with the eye sensitivity curve. While for a 455 nm line emitter the LE is just below 33 lm/Wₒₚₜ, at 465 nm this is 50 lm/Wₒₚₜ, so this outperforms the difference in EQE. Furthermore, with a longer wavelength blue primary in the overall spectrum the cyan gap as typically present in a laser-phosphor (or LED-phosphor) output spectrum is reduced and with that the CRI is increased. Therefore it is advantageous to use the longer wavelength blue where possible as the blue contribution in the white output light of a light engine. Thanks to the very small etendue of the LDs the laser beams can be collimated very well, and thanks to the narrow spectral width of LDs of only a few nm, dichroic beam splitting and combining is possible for such beams with quite small difference in wavelength of these beams. This enables configurations in which the longer WL is substantially used as a contribution in the white output light as well as (partly) used for pumping one or more luminescent material 200s. Thanks to the typically quite broad absorption spectra of e.g. garnet or nitride phosphors, these materials can be excited with both the longer and the shorter blue WL laser beams.

Thanks to the application of a birefringent rotator, the color temperature of the output light can be adjusted without substantially changing the light engine output power while keeping the input power constant. Thanks to the use of a partially polarizing beam splitter, the light engine shows high efficiency. Thanks to the configuration that is based purely on diffuse reflected laser light, a light engine with high robustness concerning eye safety is realized. The use of a dichroic beam splitter in combination with the combined polarizing beam splitter-dichroic beam splitter (PBS-DBS) enables further increased light engine output flux and radiance.

Referring to FIG. 1, the output of a first laser source with λ1 is projected on a reflective luminescent converter. The polarization of the output of a second laser source with λ2 is set via a birefringent rotator, by which a selected portion is transmitted by a combined dichroic beam splitter and partially polarizing beam splitter, indicated as central optics 900, towards the luminescent converter and the remaining portion is reflected towards a reflective diffuser. Via the same combined central optics 900 the diffused blue laser light 711 and the luminescent material light 201 are combined into white output light.

Working principles of this basic configuration of the laser-phosphor light engine:
1. A first blue beam with a first (shortest) wavelength from a first laser source with arbitrary polarization transmits through a first dichroic beam splitter 515, first dichroic beam splitter 515, to be projected onto a spinning wheel track comprising a luminescent material 200;
2. A second blue beam with a different, longer wavelength from a second laser source that is substantially polarized is configured via a birefringent rotator into a beam comprising two polarization contributions that have a preferred p/s polarization ratio with reference to the polarizing beam splitter;
3. By adjusting the orientation of the rotator axis, the ratio of the two polarization contributions in the beam from the second laser source is changed by which the power ratio of the two beams created by the polarizing beam splitter and with that the color point of the resulting light engine (white) output light is finetuned;
4. The central optics 900 (here central optics polarizing beam splitter and (blue-yellow) central optics dichroic beam splitter) transmits the p-pol. long WL blue light 121 to first dichroic beam splitter 515;
5. The central optics 900 (here central optics polarizing beam splitter 910 and (blue-yellow) central optics dichroic beam splitter 920) reflects a portion of the s-pol. long WL blue light 121 towards a reflective diffuser, and transmits a (complementary) portion of the s-pol. long WL blue light 121 to first dichroic beam splitter 515;
6. The s-pol long WL blue light 121 reflected by the central optics polarizing beam splitter 910 is converted by a λ/4 plate into circularly polarized light;
7. The substantially pol. maintaining diffuser reflects the (circularly polarized) blue light;
8. The reflected (substantially circularly polarized) diffused blue light is converted by the λ/4 plate into substantially p-pol. light;
9. The diffused blue light is now substantially transmitted by the central optics 900 to the output;
10. The first dichroic beam splitter 515 is configured to transmit the short wavelength blue light 111 from the first laser source and to reflect the long wavelength blue light from the second laser source as well as the luminescent material light 201;
11. The non-diffused transmitted (p-pol. and/or s-pol.) long WL blue light 121 is reflected by first dichroic beam splitter 515 towards the luminescent material 200;
12. The blue light projected onto the luminescent material 200, comprising the short wavelength blue light 111 from the first laser source and part of the long wavelength blue light from the second laser source, is substantially converted into luminescent material light 201;
13. The luminescent material light 201 is reflected by first dichroic beam splitter 515;
14. Upon reflection of the luminescent material light 201 by the central optics 900, it is combined with the diffused (long wavelength) blue light into (white) output light;
15. An optional integrator is used to further homogenize the white light beam.

Referring to FIG. 2, a diffuser is applied on the rotating phosphor wheel as an additional, concentric, track. Therefore, also in the blue contribution to the output white light no speckle is visible.

The working principles of this configuration of the laser-phosphor light engine:
1. A first blue beam with a first (shortest) wavelength from a first laser source with arbitrary polarization transmits through a first dichroic beam splitter 515 to be projected onto a spinning wheel track comprising a luminescent material 200;
2. A second blue beam with a different, longer wavelength from a second laser source that is substantially polarized is configured via a birefringent rotator into a beam comprising two polarization contributions that have a preferred p/s polarization ratio with reference to the polarizing beam splitter;
3. By adjusting the orientation of the rotator axis, the ratio of the two polarization contributions in the beam from the second laser source is changed by which the power ratio of the two beams created by the polarizing beam splitter and with that the color point of the resulting light engine (white) output light is finetuned;
4. The central optics 900 (here central optics polarizing beam splitter and (blue-yellow) central optics dichroic beam splitter) transmits the p-pol. long WL blue light 121 to first dichroic beam splitter 515;
5. The central optics 900 (here central optics polarizing beam splitter and (blue-yellow) central optics dichroic beam splitter) reflects a portion of the s-pol. long WL blue light 121 towards a reflective diffuser, and transmits a (complementary) portion of the s-pol. long WL blue light 121 to first dichroic beam splitter 515;
6. The s-pol long WL blue light 121 reflected by the polarizing beam splitter is converted by a λ/4 plate into circularly polarized light;
7. The substantially pol. maintaining diffuser reflects the (circularly polarized) blue light;
8. The reflected (substantially circularly polarized) diffused blue light is converted by the λ/4 plate into substantially p-pol. light;
9. The diffused blue light is now substantially transmitted by the central optics 900 to the output;
10. The first dichroic beam splitter 515 is configured to transmit the short wavelength blue light 111 from the first laser source and to reflect the long wavelength blue light from the second laser source as well as the luminescent material light 201;
11. The non-diffused transmitted (p-pol. and/or s-pol.) long WL blue light 121 is reflected by first dichroic beam splitter 515 towards the luminescent material 200;
12. The blue light projected onto the luminescent material 200, comprising the short wavelength blue light 111 from the first laser source and part of the long wavelength blue light from the second laser source, is substantially converted into luminescent material light 201;
13. The luminescent material light 201 is reflected by first dichroic beam splitter 515;
14. Upon reflection of the luminescent material light 201 by the central optics 900, it is combined with the diffused (long wavelength) blue light into (white) output light;
15. An optional integrator 550 is used to further homogenize the white light beam;

Referring to FIG. 3, in an alternative embodiment #2 the dichroic beam splitter and combined central optics 900 components are transmissive for the luminescent material light 201 (where these components as presented in the basic configuration and in alternative embodiment #1 are transmissive for the luminescent material light 201). This is presented in FIG. 3. Here, beam splitter/combiner components that are transmissive for the luminescent material light 201.

Working principles of this alternative embodiment #2:
1. A first blue beam with a first (shortest) wavelength from a first laser (array) source with arbitrary polarization reflects at a first dichroic beam splitter 515 (first dichroic beam splitter 515) to be projected onto a spinning wheel track comprising a luminescent material 200;
2. A second blue beam with a different, longer wavelength from a second laser (array) source is substantially polarized and configured via a birefringent rotator to provide an adjustable ratio of p- and s-polarization;
3. A polarizing beam splitter splits the long WL blue light 121 into two beams, one of which (s-pol.) is reflected by the blue polarizing beam splitter (and blue-yellow dichroic beam splitter) towards the first dichroic beam splitter 515 (to be there transmitted to the luminescent converter), and the other (p-pol.) is partly reflected towards first dichroic beam splitter 515 and partly transmitted to a diffusing reflector;
4. The rotator axis is set to achieve the required ratio of the two polarized beams from the second laser source by which the color point of the resulting (white) output light is fine-tuned;
5. The (p-pol.) long WL blue light 121 transmitted through the central optics 900 is converted by a λ/4 plate into circularly pol. light;
6. The substantially pol. maintaining diffuser reflects the long WL blue light 121;
7. The reflected (substantially circularly polarized) diffused long WL blue light 121 is converted by the λ/4 plate into substantially s-pol. light;
8. The diffused long WL blue light 121 is now substantially reflected by the central optics 900 to the output;
9. The non-diffused reflected (s-pol. and/or p-pol.) long WL blue light 121 is transmitted by the first dichroic beam splitter 515 towards the luminescent material 200 track on the spinning wheel;
10. The blue light projected onto the luminescent material 200, comprising the short wavelength blue light 111 from the first laser source and part of the long wavelength blue light from the second laser source, is substantially converted into luminescent material light 201;
11. The luminescent material light 201 is collected by the condenser lenses and transmitted by first dichroic beam splitter 515;
12. Upon transmission of the luminescent material light 201 by the central optics 900, it is combined with the diffused (long wavelength) blue light into (white) output light;
13. An optional integrator 550 is used to further homogenize the white light beam.

Note that in these configurations, also the polarizing beam splitter functionality has changed, as it now splits the s-polarized blue light into two substantial, respectively transmitted and reflected, parts, and transmits basically all the p-polarized blue light.

Thanks to the use of a dichroic beam splitter for redirecting the luminescent material light 201 out of the beam of the short wavelength blue pump light, the light engine output power and output radiance can be further increased by combining two short wavelength blue laser (array) sources via a first polarizing beam splitter 525 before being input to first dichroic beam splitter 515. This is therefore included here as an alternative embodiment #3, in which additionally the luminescent conversion and the reflective diffusion are combined again as two spots on a single rotating component with two concentric tracks for the conversion and the diffusion, respectively. This requires the addition of an additional mirror, but by that again enables a compact configuration with absolute speckle-free engine light output.

This configuration is presented in FIG. 4. In FIG. 4, an increased light engine output power and (optionally) radiance by combining two short wavelength blue sources via a first polarizing beam splitter 525. In addition, the luminescent conversion and the reflective diffusion are combined at two locations on a single rotating component (spinning wheel).

Working principles of alternative embodiment #3:
1. A first blue beam with a first (shortest) wavelength from a first laser (array) source configured to provide s-polarized light and a second blue beam with a first (shortest) wavelength from a second laser (array) source configured to provide p-polarized light are combined via a first polarizing beam splitter polarizing beam splitter;
2. The combined shortest wavelength blue beam is homogenized by an integrator and reflects at a first dichroic beam splitter (first dichroic beam splitter 515) to be projected onto a spinning wheel track comprising a luminescent material 200;
3. A third blue beam with a different, longer wavelength from a third laser (array) source provides substantially polarized light and is configured via a birefringent rotator to provide an adjustable ratio of p- and s-polarization;
4. A polarizing beam splitter splits the long WL blue light 121 into a reflected and a transmitted beam; the s-pol. light is reflected by the blue polarizing beam splitter (and blue-yellow dichroic beam splitter) towards the first dichroic beam splitter 515 (to be there transmitted to the luminescent converter), and the p-pol. light is partly reflected towards first dichroic beam splitter 515 and partly transmitted to a reflective diffuser track on the spinning wheel;
5. The rotator axis is set to achieve the required ratio of the two polarized beams from the third laser source by which the color point of the resulting (white) output light is fine-tuned;
6. The (p-pol.) long WL blue light 121 transmitted through the central optics 900 is redirected by a mirror, converted by a λ/4 plate into circularly pol. light, and projected onto the diffuser track on the spinning wheel;
7. The substantially pol. maintaining diffuser reflects the long WL blue light 121;
8. The reflected (substantially circularly polarized) diffused long WL blue light 121 is collected by the condenser lenses and converted by the λ/4 plate into substantially s-pol. light;
9. The diffused long WL blue light 121 is now substantially reflected by the central optics 900 to the output;
10. The non-diffused reflected (s-pol. and/or p-pol.) long WL blue light 121 is transmitted by the first dichroic beam splitter 515 towards the luminescent material 200 track on the spinning wheel;
11. The blue light projected onto the luminescent material 200, comprising the short wavelength blue light 111 from the first and second laser sources and part of the long wavelength blue light from the third laser source, is substantially converted into luminescent material light 201;
12. The luminescent material light 201 is collected by the condenser lenses and transmitted by first dichroic beam splitter 515;
13. Upon transmission of the luminescent material light 201 by the central optics 900, it is combined with the diffused (long wavelength) blue light into (white) output light 14. An optional integrator 550 is used to further homogenize the white light output beam.

In an alternative embodiment #4, the first dichroic beam splitter 515 is reflective for the luminescent material light 201, while the combined central optics 900 is transmissive for luminescent material light 201.

This configuration is presented in FIG. 5. Herein, the first dichroic beam splitter 515 is reflective for the luminescent material light 201, while central optics 900 is transmissive for the luminescent material light 201.

Working principles of alternative embodiment #4:
1. A first blue beam with a first (shortest) wavelength from a first laser (array) source with arbitrary polarization is transmitted through a first dichroic beam splitter 515 (first dichroic beam splitter 515) to be projected onto a spinning wheel track comprising a luminescent material 200;
2. A second blue beam with a different, longer wavelength from a second laser (array) source is substantially polarized and configured via a birefringent rotator to provide an adjustable ratio of p- and s-polarization;
3. A polarizing beam splitter splits the long WL blue light 121 into two beams, one of which (s-pol.) is reflected by the blue polarizing beam splitter (and blue-yellow dichroic beam splitter) towards the first dichroic beam splitter 515 (to be there transmitted to the luminescent converter), and the other (p-pol.) is partly reflected towards first dichroic beam splitter 515 and partly transmitted to a diffusing reflector;
4. The optical axis of the birefringent rotator is set to achieve the required ratio of the two polarized beams from the second laser source (achieved after incidence on the polarizing beam splitter) by which the color point of the resulting (white) output light is fine-tuned.
5. The (p-pol.) long WL blue light 121 transmitted through the central optics 900 is converted by a λ/4 plate into circularly pol. light;
6. The substantially pol. maintaining diffuser reflects the long WL blue light 121;
7. The reflected (substantially circularly polarized) diffused long WL blue light 121 is converted by the λ/4 plate into substantially s-pol. light;
8. The diffused long WL blue light 121 is now substantially reflected by the central optics 900 to the output;
9. The non-diffused reflected (s-pol. and/or p-pol.) long WL blue light 121 is reflected by the first dichroic beam splitter 515 towards the luminescent material 200 track on the spinning wheel;
10. The blue light projected onto the luminescent material 200, comprising the short wavelength blue light 111 from the first laser source and part of the long wavelength blue light from the second laser source, is substantially converted into luminescent material light 201;
11. The luminescent material light 201 is collected by the condenser lenses and reflected by first dichroic beam splitter 515;
12. Upon transmission of the luminescent material light 201 by the central optics 900, it is combined with the diffused (long wavelength) blue light into (white) output light;
13. An optional integrator 550 is used to further homogenize the white light beam.

In an alternative embodiment #5, the first dichroic beam splitter 515 is transmissive for the luminescent material light 201, while the combined central optics 900 is reflective for luminescent material light 201.

This configuration is presented in FIG. 6. Herein, the first dichroic beam splitter 515 is transmissive for the luminescent material light 201, while central optics 900 is reflective for the luminescent material light 201.

Working principles of alternative embodiment #5:
1. A first blue beam with a first (shortest) wavelength from a first laser (array) source with arbitrary polarization reflects at a first dichroic beam splitter 515 (first dichroic beam splitter 515) to be projected onto a spinning wheel track comprising a luminescent material 200;
2. A second blue beam with a different, longer wavelength from a second laser (array) source is substantially polarized and configured via a birefringent rotator to provide an adjustable ratio of p- and s-polarization;
3. A polarizing beam splitter splits the long WL blue light 121 into two beams, one of which (s-pol.) is partly transmitted by the blue polarizing beam splitter (and blue-yellow dichroic beam splitter) towards the first dichroic beam splitter 515 (to be there transmitted to the luminescent converter) and partly reflected towards the diffuse reflector, and the other (p-pol.) is transmitted towards first dichroic beam splitter 515;
4. The rotator axis is set to achieve the required ratio of the two polarized beams from the second laser source by which the color point of the resulting (white) output light is fine-tuned;
5. The (s-pol.) long WL blue light 121 reflected by the central optics 900 is converted by a λ/4 plate into circularly pol. light;
6. The substantially pol. maintaining diffuser reflects the long WL blue light 121;
7. The reflected (substantially circularly polarized) diffused long WL blue light 121 is converted by the λ/4 plate into substantially p-pol. light;
8. The diffused long WL blue light 121 is now substantially transmitted by the central optics 900 to the output;
9. The non-diffused transmitted (s-pol. and/or p-pol.) long WL blue light 121 is transmitted by the first dichroic beam splitter 515 towards the luminescent material 200 track on the spinning wheel;
10. The blue light projected onto the luminescent material 200, comprising the short wavelength blue light 111 from the first laser source and part of the long wavelength blue light from the second laser source, is substantially converted into luminescent material light 201;
11. The luminescent material light 201 is collected by the condenser lenses and transmitted by first dichroic beam splitter 515;
12. Upon reflection of the luminescent material light 201 by the central optics 900, it is combined with the diffused (long wavelength) blue light into (white) output light;
13. An optional integrator 550 is used to further homogenize the white light beam.

It may be obvious that multiple other permutations of building blocks/subsystems as presented so far are covered as further embodiments according to the principles of this invention as well. As an example, the combination of two laser beams, that have been configured to have orthogonal polarization, via a first polarizing beam splitter 525 (as described in FIG. 4 for one specific configuration) is applicable to all other embodiments presented here as well. Obviously, such orthogonality of the polarization of the beams from two laser (array) sources may be achieved by using a retarder in front of one of the sources. Further, to improve the homogeneity of the luminance and/or color point distribution in the beam, one or more small angle transmissive diffusers may be inserted in the optical path of one or more of the beams in the system.

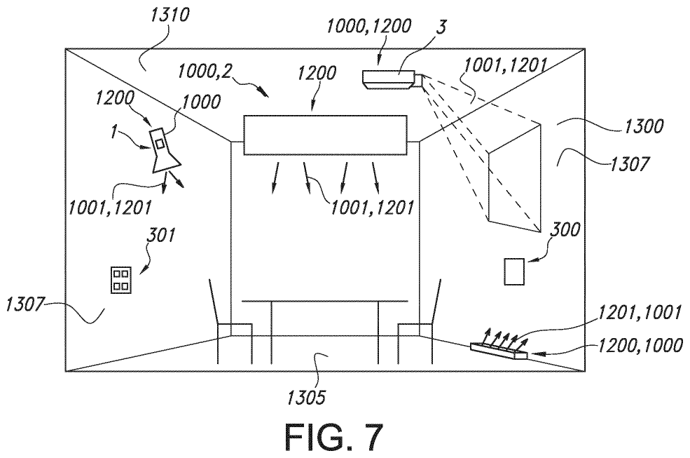

FIG. 7 schematically depicts an embodiment of a luminaire 2 comprising the light generating system 1000 as described above. Reference 301 indicates a user interface which may be functionally coupled with the control system 300 comprised by or functionally coupled to the light generating system 1000. FIG. 7 also schematically depicts an embodiment of lamp 1 comprising the light generating system 1000. Reference 3 indicates a projector device or projector system, which may be used to project images, such as at a wall, which may also comprise the light generating system 1000. Hence, FIG. 7 schematically depicts embodiments of a lighting device 1200 selected from the group of a lamp 1, a luminaire 2, a projector device 3, a disinfection device, a photochemical reactor, and an optical wireless communication device, comprising the light generating system 1000 as described herein. In embodiments, such lighting device may be a lamp 1, a luminaire 2, a projector device 3, a disinfection device, or an optical wireless communication device. Lighting device light escaping from the lighting device 1200 is indicated with reference 1201. Lighting device light 1201 may essentially consist of system light 1001, and may in specific embodiments thus be system light 1001. Reference 1300 refers to a space, such as a room. Reference 1305 refers to a floor and reference 1310 to a ceiling; reference 1307 refers to a wall.

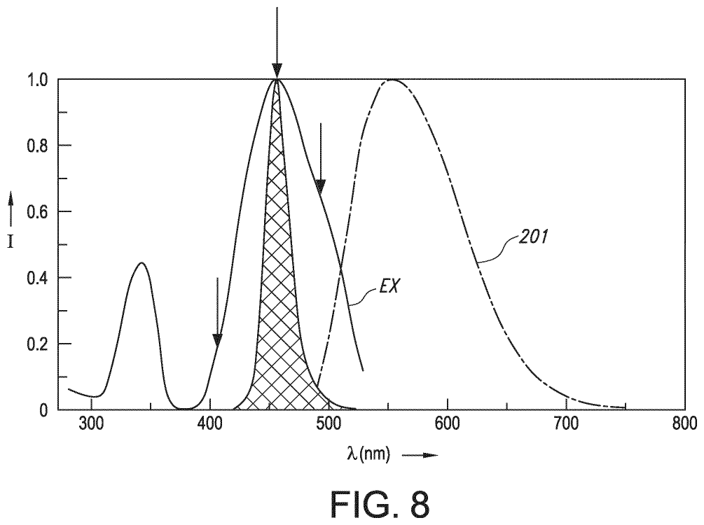

Referring to FIG. 8, an excitation spectrum EX is depicted, as well the related luminescent material light 201 for a specific luminescent material. Referring to the arrows, these indicate possible (but not exclusive) positions of the peak wavelengths. As indicated above, the peak wavelengths of the first device light and the second device light are not the same. As shown in the Figure, λ1−λ2|≥5 nm. Here, the arrows schematically depict, just by way of example, different positions for the peak wavelengths. As indicated above, in specific embodiments, the first peak wavelength may be selected at a spectral position of maximum absorption of the luminescent material (middle arrow), and the second peak wavelength thus at a position of at least 5 nm, more especially at least 10 nm, blue shifted (left arrow) or red shift (right arrow), especially red shifted. In other embodiments, the first peak wavelength may and the second peak wavelength may both be selected at a spectral position offset from maximum absorption of the luminescent material. For instance, one may be a blue shifted (left arrow) relative to the maximum absorption and the other one may be red shifted (right arrow) relative to the maximum absorption.

The term “plurality” refers to two or more.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%.

The term “comprise” also includes embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage. In yet a further aspect, the invention (thus) provides a software product, which, when running on a computer is capable of bringing about (one or more embodiments of) the method as described herein.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A light generating system comprising a first light generating device, a second light generating device, a luminescent material, first optics, a polarization control element, a diffuser element, a polarization changing element, and central optics, wherein:
the first light generating device is configured to generate first device light; wherein the first light generating device comprises a first light source selected from a laser diode and a superluminescent diode; wherein the first device light has a first peak wavelength λ1;
the second light generating device is configured to generate second device light, wherein the second device light comprises one or more of polarized light having a p polarization and polarized light having an s polarization; wherein the second light generating device comprises a second light source selected from a laser diode and a superluminescent diode; wherein the second device light has a second peak wavelength λ2; wherein |λ1−λ2|≥5 nm;
the luminescent material is configured to convert first device light and second device light received by the luminescent material into luminescent material light;
the first optics comprise a first dichroic beam splitter, wherein the first dichroic beam splitter is configured (a) to transmit or reflect at least part of the first device light, and (b) to reflect or transmit at least part of the luminescent material light;
the polarization control element is configured to control polarization of the second device light;
the diffuser element is configured to diffuse at least part of the second device light received by the diffuser element thereby providing diffused second device light while maintaining at least part of the polarization of the second device light;
the polarization changing element is configured in an optical path of the second device light between the central optics and the diffuser element;
the central optics comprises (i) a central optics polarizing beam splitter, and (ii) a central optics dichroic beam splitter; wherein the central optics polarizing beam splitter is configured to transmit and/or reflect at least part of the second device light in dependence of its polarization; and wherein the central optics dichroic beam splitter is configured (a) to transmit or reflect at least part of the second device light, and (b) to reflect or transmit at least part of the luminescent material light;
the light generating system is configured to provide system light comprising diffused second device light and luminescent material light; and wherein the light generating system is configured such that in a first operational mode of the light generating system (a) at least part of the first device light irradiates the luminescent material via the first optics, and the luminescent material light escapes from the light generating system via the first optics and the central optics and (b) at least part of the second device light irradiates the diffuser element via the central optics, and at least part of the diffused second device light escapes from the light generating system via the central optics; and
wherein (i) the first dichroic beam splitter is configured (a) to transmit at least 80% of the first device light received by the first dichroic beam splitter, and (b) to reflect at least 80% of the luminescent material light received by the first dichroic beam splitter and at least 80% of the second device light received by the first dichroic beam splitter, or (ii) the first dichroic beam splitter is configured (a) to reflect at least 80% of the first device light received by the first dichroic beam splitter, and (b) to transmit at least 80% of the luminescent material light received by the first dichroic beam splitter and at least 80% of the second device light received by the first dichroic beam splitter;
wherein the central optics polarizing beam splitter is configured to transmit x % of light having p polarization and reflect y % of light having s polarization, wherein one of x % and y % is selected from the range of 15-80%, and the other one of x % and y % is selected from the range of 85-100%.

2. The light generating system according to claim 1, wherein the first device light and the second device light have a wavelength selected from the blue wavelength range; wherein the luminescent material light has a wavelength selected from the green-red wavelength range, and wherein the system light in the first operational mode is white light; wherein the polarization control element is configured to control a degree of polarization of the second device light; wherein the diffuser element is configured to diffuse at least part of the second device light received by the diffuser element; wherein the central optics comprises (i) a single optical component having polarizing beam splitting functionality and dichroic beam splitting functionality, or (ii) two optical components, one having polarizing beam splitting functionality and one having dichroic beam splitting functionality; wherein |λ1−λ2|≥10 nm; wherein λ2>λ1; and wherein the polarization changing element comprises a λ/4 waveplate.

3. The light generating system according to claim 1, wherein the polarization control element comprises a rotatable birefringent rotator; wherein the birefringent rotator comprises a λ/2 waveplate.

4. The light generating system according to claim 1, further comprising a control system, wherein the control system is configured to control a spectral power distribution of the system light by controlling one or more of (i) the polarization control element, (ii) a radiant flux of the first device light, and (iii) a radiant flux of the second device light.

5. The light generating system according to claim 4, wherein the control system is configured to control a correlated color temperature of the system light in dependence of one or more of a user interface, a sensor signal, and a timer.

6. The light generating system according to claim 1, wherein the central optics dichroic beam splitter is configured (a) to transmit at least 80% of the second device light received by the central optics dichroic beam splitter, and to reflect at least 80% of the luminescent material light received by the central optics dichroic beam splitter, or (b) to reflect at least 80% of the second device light received by the central optics dichroic beam splitter, and to transmit at least 80% of the luminescent material light received by the central optics dichroic beam splitter.

7. (canceled)

8. The light generating system according to claim 1, comprising a primary first light generating device and a secondary first light generating device, wherein the device light of one of the primary first light generating device and the secondary first light generating device, comprises more s-polarized than the other one of the primary first light generating device and the secondary first light generating device, wherein the light generating system further comprises second optics, configured downstream of the primary first light generating device and the secondary first light generating device and configured upstream of the first optics, wherein the second optics comprises a first polarizing beam splitter, wherein the first polarizing beam splitter is configured to reflect s-polarized light and to transmit p-polarized light.

9. The light generating system according to claim 7, wherein the device light of the other one of the primary first light generating device and the secondary first light generating device, comprises more p-polarized than the one of the primary first light generating device and the secondary first light generating device.

10. The light generating system according to claim 1, comprising a plurality of first light generating devices configured in a first laser bank, wherein the first light generating devices are configured to generate the first device light, wherein the first device light is laser light; and/or a plurality of second light generating devices configured in a second laser bank, wherein the second light generating devices are configured to generate the second device light, wherein the second device light is laser light.

11. The light generating system according to claim 1, comprising a rotatable element, wherein the rotatable element comprises the luminescent material; wherein during operation of the light generating system in the first operational mode the rotatable element rotates, such that over time different parts of the luminescent material are irradiated by the first device light and/or second device light.

12. The light generating system according to claim 10, wherein the rotatable element also comprises the diffuser element, spatially separated from the luminescent material; wherein during operation of the light generating system the rotatable element rotates, such that over time different parts of the diffuser element are irradiated by the second device light.

13. The light generating system according to claim 1, wherein the luminescent material is configured in thermal contact with a thermally conductive material.

14. The light generating system according to claim 1, further comprising one or more of integrating optics, collimation optics, and homogenization optics; and wherein the luminescent material comprises at least two different luminescent materials configured to provide luminescent material light having different spectral power distributions; wherein the luminescent material at least comprises a luminescent material of the type A₃B₅O₁₂:Ce, wherein A comprises one or more of Y, La, Gd, Tb and Lu, and wherein B comprises one or more of Al, Ga, In and Sc.

15. A lighting device selected from the group of a lamp, a luminaire, a projector device, a headlamp, and an optical wireless communication device, comprising the light generating system according to claim 1.
